(19) United States
(12) Patent Application Publication
(10) Pub. No.: US 2025/0247127 A1
(43) Pub. Date: Jul. 31, 2025

(54) WIRELESS AUDIO TRANSMITTING DEVICE, WIRELESS AUDIO RECEIVING DEVICE, AND WIRELESS AUDIO SYSTEM INCLUDING THE SAME

(71) Applicant: LG ELECTRONICS INC., Seoul (KR)

(72) Inventors: Jisung Yang, Seoul (KR); Joonseok Maeng, Seoul (KR); Jiwan Jeung, Seoul (KR); Seunghyun Lee, Seoul (KR); Dawoon Lee, Seoul (KR)

(73) Assignee: LG ELECTRONICS INC., Seoul (KR)

(21) Appl. No.: 18/887,664

(22) Filed: Sep. 17, 2024

(30) Foreign Application Priority Data
Jan. 31, 2024 (KR) 10-2024-0014943

(51) Int. Cl. H04B 1/7163; G06F 3/16

(52) U.S. Cl. CPC H04B 1/71632; G06F 3/162

(57) ABSTRACT

A wireless audio transmitting device, a wireless audio receiving device, and a wireless audio system including the same are disclosed. The wireless receiving device of the present disclosure includes a communication device to receive an audio signal from a audio transmitting device through ultra-wireless wideband communication; and a power supply to supply power to the communication device, wherein the communication is configured to operate based on a power of a first level in response to receiving a first beacon signal, and operate based on a power of a second level lower than the first level or turn off, in response to receiving end frame information from the wireless audio transmitting device, after receiving the first beacon signal. Accordingly, power consumption during ultra-wideband communication can be reduced.

### BACKGROUND

### 1. Field

This disclosure relates to a wireless audio transmitting device, a wireless audio receiving device, and a wireless audio system including the same, and more particularly, to a wireless audio transmitting device, a wireless audio receiving device, and wireless audio system including the same capable of reducing power consumption during ultra-wideband communication.

### 2. Description of the Related Art

A wireless audio transmitting device wirelessly transmits an audio signal to an external wireless audio receiving device.

In response to this, a wireless audio receiving device wirelessly receives an audio signal from an external wireless audio transmitting device, converts the received audio signal into sound, and outputs the sound.

Meanwhile, in order to avoid interference with surrounding signals or output high-quality sound, research using an ultra-wideband (UWB) communication method between a wireless audio transmitting device and a wireless audio receiving device is being conducted.

Meanwhile, during ultra-wideband (UWB) communication, there is a disadvantage that a significant amount of power is consumed to receive data from a wireless audio receiving device.

### SUMMARY

The disclosure has been made in view of the above problems, and may provide a wireless audio transmitting device, a wireless audio receiving device, and a wireless audio system including the same capable of reducing power consumption during ultra-wideband communication.

The disclosure may further provide a wireless audio transmitting device, a wireless audio receiving device, and a wireless audio system including the same capable of stably sharing wireless audio data through ultra-wideband communication.

In accordance with an aspect of the present disclosure, a wireless audio receiving device and a wireless audio system including the same include: a communication device which receives an audio signal from a wireless audio transmitting device through ultra-wideband communication; and a power supply configured to supply power to the communication device, wherein the communication is configured to operate based on a power of a first level in response to receiving a first beacon signal, and operate based on a power of a second level lower than the first level or turn off, in response to receiving end frame information from the wireless audio transmitting device, after receiving the first beacon signal.

Meanwhile, in response to no transmission data to be transmitted to the wireless audio transmitting device, the communication is configured to operate based on the power of the second level or turn off, from a time of receiving the end frame information until a time of receiving a second beacon signal following the first beacon signal.

Meanwhile, in response to transmission data to be transmitted to the wireless audio transmitting device, the communication device is configured to transmit the transmission data after receiving the end frame information, and operate based on the power of the second level turn off, after transmitting the transmission data until receiving a second beacon signal following the first beacon signal.

Meanwhile, when receiving data after receiving the first beacon signal, receiving the end frame information, and no transmission data to be transmitted to the wireless audio transmitting device, the communication device is configured to operate based on the power of the second level or turn off, after receiving the end frame information until receiving a second beacon signal following the first beacon signal.

Meanwhile, when receiving data after receiving the first beacon signal, and receiving the end frame information, and there is transmission data to be transmitted to the wireless audio transmitting device, the communication device is configured to transmit the transmission data after receiving the end frame information, and operate based on the power of the second level or turn off, after transmitting the transmission data until receiving a second beacon signal following the first beacon signal.

Meanwhile, the communication device is configured to receive the end frame information through a network address or broadcast address of the wireless audio receiving device.

Meanwhile, in response to receiving the end frame information, the communication is configured to operate based on the power of the second level or turn off, in at least partial section of an active period in a beacon interval.

Meanwhile, in response to no data to be transmitted to the wireless audio transmitting device, the communication is configured to operate based on the power of the second level or turn off, after receiving the end frame information until: receiving a second beacon signal following the first beacon signal.

Meanwhile, in response to transmission data to be transmitted to the wireless audio transmitting device, the communication device is configured to transmit the transmission data after receiving the end frame information, and operate based on the power of the second level or turn off, after transmitting the transmission data until receiving a second beacon signal following the first beacon signal.

Meanwhile, in response to receiving the end frame information, the communication is configured to operate based on the power of the second level or turn off, in at least partial section of a contention access period in a beacon interval.

Meanwhile, in response to no data to be transmitted to the wireless audio transmitting device, the communication is configured to operate based on the power of the second level or turn off, after receiving the end frame information until receiving a second beacon signal following the first beacon signal.

Meanwhile, in response to transmission data to be transmitted to the wireless audio transmitting device, the communication device is configured to transmit the transmission data after receiving the end frame information, and operate based on the power of the second level or turn off, after transmitting the transmission data until receiving a second beacon signal following the first beacon signal.

Meanwhile, in response to receiving the end frame information during one-to-one connection or one-to-many connection with the wireless audio transmitting device, the communication is configured to operate based on the power of the second level or turn off, during at least partial section of a contention access period in a beacon interval.

Meanwhile, the power supply is configured to supply a power of a third level when the communication device is configured to receive a first beacon signal, and supply a power of a fourth level lower than the third level when the communication device is configured to receive end frame information from the wireless audio transmitting device after receiving the first beacon signal.

Meanwhile, a wireless audio receiving device and a wireless audio system including the same further include a sound output device is configured to output sound corresponding to an audio signal received from the communication device.

In accordance with another aspect of the present disclosure, a wireless audio transmitting device and a wireless audio system including the same include a communication device is configured to transmit an audio signal through an ultra-wideband communication; and a power supply configured to supply power to the communication device, wherein the communication device is configured to transmit end frame information from a wireless audio receiving device, after transmitting a first beacon signal.

Meanwhile, the communication device is configured to transmit the end frame information through a network address of the wireless audio receiving device during one-to-one connection with the wireless audio receiving device.

Meanwhile, the communication device is configured to transmit the end frame information through a broadcast address, during one-to-many connection with a plurality of wireless audio receiving devices.

Meanwhile, the communication device is configured to receive data from a wireless audio receiving device after transmitting end frame information.

### BRIEF DESCRIPTION OF THE DRAWINGS

The above and other objects, features and advantages of the present disclosure will be more apparent from the following detailed description in conjunction with the accompanying drawings, in which:

FIGS. 1A to 1E are diagrams illustrating a wireless audio system including a wireless audio receiving device and a wireless audio transmitting device according to various embodiments of the present disclosure;

FIG. 2A is an example of an internal block diagram of the wireless audio receiving device of FIGS. 1A to 1E;

FIG. 2B is an example of an internal block diagram of the wireless audio transmitting device of FIGS. 1A to 1E;

FIGS. 3A to 8B are diagrams for explaining an operation of a wireless audio receiving device or a wireless audio transmitting device according to an embodiment of the present disclosure;

FIG. 9A is a diagram illustrating a beacon interval in ultra-wideband communication;

FIG. 9B is a diagram for explaining FIG. 9A;

FIG. 10A is a diagram illustrating an example of an audio exclusive transmission mode in ultra-wideband communication;

FIG. 10B is a diagram illustrating an example of an audio sharing mode in ultra-wideband communication;

FIGS. 11A and 11B are diagrams illustrating various examples of wireless data transmission methods related to the present disclosure;

FIG. 12A is a flowchart illustrating a method of operating a wireless audio receiving device according to an embodiment of the present disclosure;

FIG. 12B is a flowchart illustrating a method of operating a wireless audio receiving device according to another embodiment of the present disclosure;

FIG. 12C is a flowchart illustrating a method of operating a wireless audio system according to an embodiment of the present disclosure; and

FIGS. 13A to 15 are diagrams for explaining FIGS. 12A to 12C.

### DETAILED DESCRIPTION

Hereinafter, the present disclosure will be described in more detail with reference to the drawings.

The suffixes such as “module” and “unit” may be used to refer to elements or components. Use of such suffixes herein is merely intended to facilitate description of the specification, and the suffixes do not have any special meaning or function. Accordingly, the “module” and “unit” may be used interchangeably.

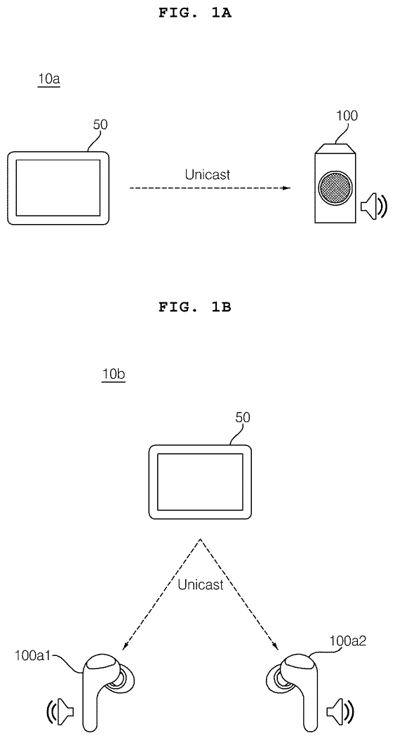

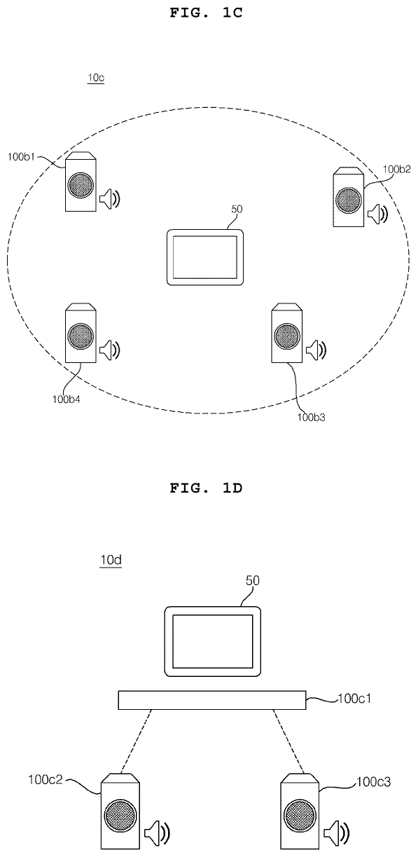

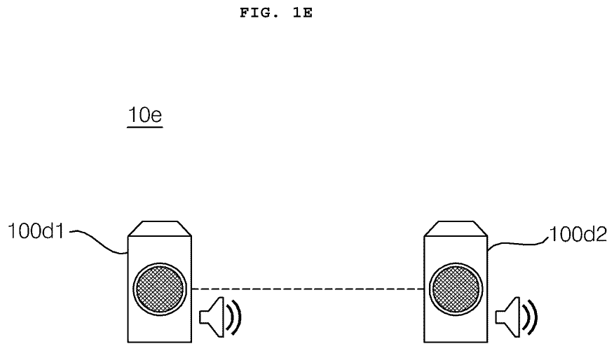

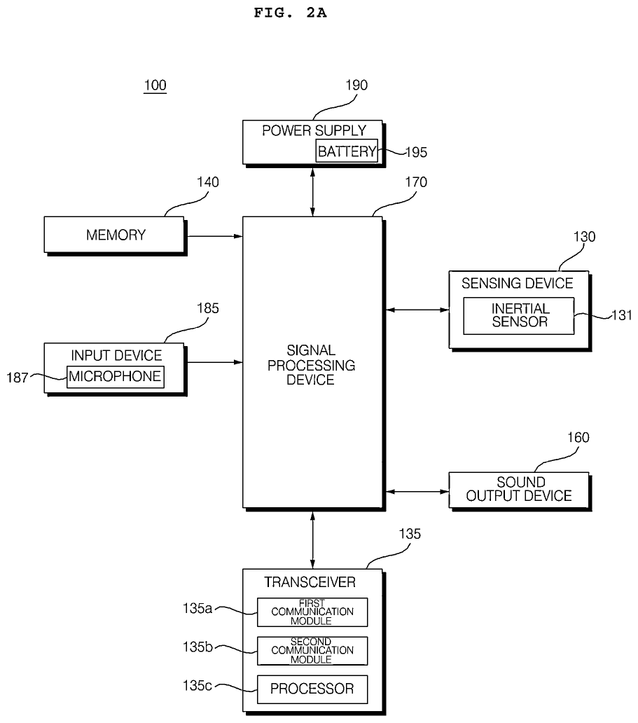

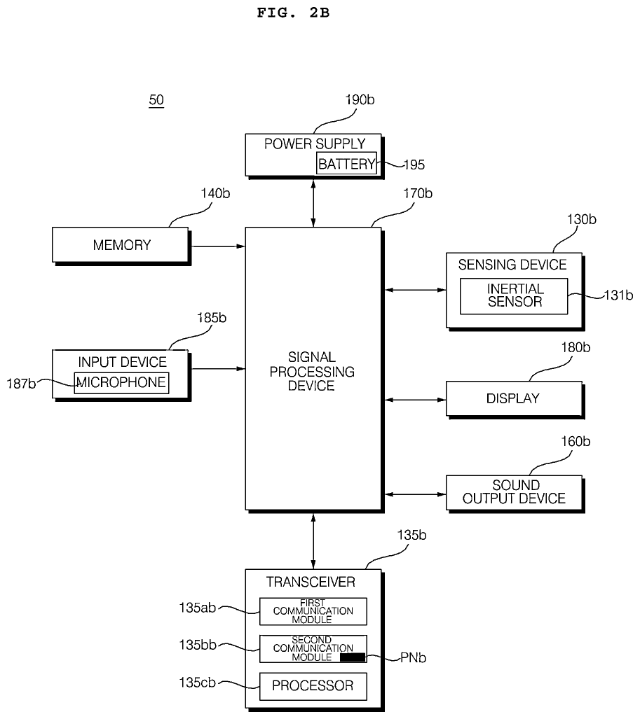

FIGS. 1A to 1E are diagrams illustrating a wireless audio system including a wireless audio receiving device and a wireless audio transmitting device according to various embodiments of the present disclosure.

First, FIG. 1A illustrates a wireless audio system 10a according to an embodiment of the present disclosure.

Referring to FIG. 1A, the wireless audio system 10a according to an embodiment of the present disclosure may include a wireless audio transmitting device 50 and a wireless audio receiving device 100.

In particular, in the wireless audio system 10a, the wireless audio transmitting device 50 and the wireless audio receiving device 100 may correspond one-to-one, based on a unicast method.

The wireless audio transmitting device 50 may include a first communication module 135a wirelessly transmitting a first audio signal according to a first communication standard of a first frequency band, and a second communication module 135b wirelessly transmitting a second audio signal according to a second communication standard of a second frequency band greater than the first frequency band.

Meanwhile, the wireless audio receiving device 100 may include a first communication module 135a wirelessly receiving a first audio signal according to a first communication standard of a first frequency band, and a second communication module 135b wirelessly receiving a second audio signal according to a second communication standard of a second frequency band greater than the first frequency band.

For example, the wireless audio receiving device 100 may wirelessly output a first sound based on a first audio signal according to a first communication standard of a first frequency band received by the first communication module 135a, and when the wireless environment is complicated and the packet error rate of the first audio signal is greater than or equal to a certain value, may output a second sound, based on a second audio signal wirelessly according to the second communication standard of a second frequency band received by the second communication module 135b.

Accordingly, even when the wireless environment is complicated, it is possible to stably receive audio wirelessly and output sound.

Meanwhile, the wireless audio receiving device 100 receives a beacon signal from a first wireless audio transmitting device 50a every period Pc corresponding to a first active period Pa and a first inactive period Pb, and searches for an additional device during the first inactive period Pb. In response to receiving a second beacon signal from a second wireless audio transmitting device 50b, the wireless audio receiving device 100 transmits a connection request command to the second wireless audio transmitting device 50b, and based on the connection request command, additionally wirelessly connects to the second wireless audio transmitting device 50b based on ultra-wideband communication, during wireless connection with the first wireless audio transmitting device 50a based on ultra-wideband communication. Accordingly, t is possible to perform frequency hopping in ultra-wideband communication, by using beacon signal.

Next, FIG. 1B illustrates a wireless audio system 10b according to another embodiment of the present disclosure.

Referring to FIG. 1B, the wireless audio system 10b according to another embodiment of the present disclosure may include a wireless audio transmitting device 50 and a plurality of wireless audio receiving devices 100a1 and 100a2.

In particular, the wireless audio system 10b may include a wireless audio transmitting device 50 and a plurality of wireless audio receiving devices 100al and 100a2, based on a unicast method.

For example, when wireless audio signals of a first channel to a second channel are output from the wireless audio transmitting device 50, a wireless audio signal of the first channel may be transmitted to a first wireless audio receiving device 100al among a plurality of wireless audio receiving devices 100al and 100a2, and a wireless audio signal of the second channel may be transmitted to a second wireless audio receiving device 100a2. Accordingly, even when the wireless environment is complicated, it is possible to stably receive audio wirelessly and output sound.

Meanwhile, each of the wireless audio receiving devices 100a1 to 100a2 wirelessly outputs a first sound, based on a first audio signal according to a first communication standard of a first frequency band received by a first communication module 135a. In response to a packet error rate of the first audio signal is greater than or equal to a certain value as the wireless environment is complicated, each of the wireless audio receiving devices 100a1 to 100a2 may output a second sound, based on a second audio signal according to a second communication standard of a second frequency band received by a second communication module 135b. Accordingly, even when the wireless environment is complicated, it is possible to stably receive audio wirelessly and output sound.

Meanwhile, each of the wireless audio receiving devices 100a1 to 100a2 receives a beacon signal from a first wireless audio transmitting device 50a every period Pc corresponding to a first active period Pa and a first inactive period Pb, and searches for an additional device during the first inactive period Pb. In response to receiving a second beacon signal from a second wireless audio transmitting device 50b, each of the wireless audio receiving devices 100a1 to 100a2 transmits a connection request command to the second wireless audio transmitting device 50b, and based on the connection request command, additionally wirelessly connects to the second wireless audio transmitting device 50b based on ultra-wideband communication, during wireless connection with the first wireless audio transmitting device 50a based on ultra-wideband communication. Accordingly, it is possible to perform frequency hopping in ultra-wideband communication, by using a beacon signal.

At this time, the plurality of wireless audio receiving devices 100a1 and 100a2 may be left and right wireless audio receiving devices, respectively.

Next, FIG. 1C illustrates a wireless audio system 10c according to another embodiment of the present disclosure.

Referring to FIG. 1C, a wireless audio system 10c according to another embodiment of the present disclosure may include a wireless audio transmitting device 50 and a plurality of wireless audio receiving devices 100b1 to 100b4.

In particular, the wireless audio system 10c may include a wireless audio transmitting device 50 and a plurality of wireless audio receiving devices 100b1 to 100b4, based on a broadcast method.

For example, when wireless audio signals of first to fourth channels are output from the wireless audio transmitting device 50, a wireless audio signal of a first channel may be transmitted to a first wireless audio receiving device 100b1 among a plurality of wireless audio receiving devices 100b1 to 100b4, a wireless audio signal of a second channel may be transmitted to a second wireless audio receiving device 100b2, a wireless audio signal of a third channel may be transmitted to a third wireless audio receiving device 100b3, and a wireless audio signal of a fourth channel may be transmitted to a fourth wireless audio receiving device 100b4. Accordingly, even when the wireless environment is complicated, it is possible to stably receive audio wirelessly and output sound.

Meanwhile, each of the wireless audio receiving devices 100b1 to 100b4 wirelessly outputs a first sound, based on a first audio signal according to a first communication standard of a first frequency band received by the first communication module 135a. In response to a packet error rate of the first audio signal is greater than or equal to a certain value as the wireless environment is complicated, each of the wireless audio receiving devices 100b1 to 100b4 may output a second sound, based on a second audio signal according to a second communication standard of a second frequency band received by the second communication module 135b. Accordingly, even when the wireless environment is complicated, it is possible to stably receive audio wirelessly and output sound.

Meanwhile, each of the wireless audio receiving devices 100b1 to 100b4 receives a beacon signal from a first wireless audio transmitting device 50a every period Pc corresponding to a first active period Pa and a first inactive period Pb, and searches for an additional device during the first inactive period Pb. In response to receiving a second beacon signal from a second wireless audio transmitting device 50b, each of the wireless audio receiving devices 100b1 to 100b4 transmits a connection request command to the second wireless audio transmitting device 50b, and based on the connection request command, additionally wirelessly connects to the second wireless audio transmitting device 50b based on ultra-wideband communication, during wireless connection with the first wireless audio transmitting device 50a based on ultra-wideband communication. Accordingly, it is possible to perform frequency hopping in ultra-wideband communication, by using a beacon signal.

Next, FIG. 1D illustrates a wireless audio system 10d according to another embodiment of the present disclosure.

Referring to FIG. 1D, the wireless audio system 10d according to another embodiment of the present disclosure may include a wireless audio transmitting device 50 and a plurality of wireless audio receiving devices 100c1 to 100c3.

In particular, the wireless audio system 10d may include a wireless audio transmitting device 50 and a plurality of wireless audio receiving devices 100c1 to 100c3, based on a unicast method.

For example, when wireless audio signals of first to third channels are output from the wireless audio transmitting device 50, a wireless audio signal of a first channel may be transmitted to a first wireless audio receiving device 100c1 among a plurality of wireless audio receiving devices 100c1 to 100c3, a wireless audio signal of a second channel may be transmitted to a second wireless audio receiving device 100c2, and a wireless audio signal of a third channel may be transmitted to a third wireless audio receiving device 100c3.

As another example, when wireless audio signals of first to third channels are output from the wireless audio transmitting device 50, wireless audio signals of a first channel to a third channel may be transmitted to a first wireless audio receiving device 100cl among a plurality of wireless audio receiving devices 100c1 to 100c3, the first wireless audio receiving device 100c1 may output wireless audio signals of second to third channels, a wireless audio signal of the second channel may be transmitted to a second wireless audio receiving device 100c2, and a wireless audio signal of the third channel may be transmitted to a third wireless audio receiving device 100c3.

Accordingly, even when the wireless environment is complicated, it is possible to stably receive audio wirelessly and output sound.

Meanwhile, each of the wireless audio receiving devices 100c1 to 100c3 wirelessly outputs a first sound, based on a first audio signal according to a first communication standard of a first frequency band received by the first communication module 135a. In response to a packet error rate of the first audio signal is greater than or equal to a certain value as the wireless environment is complicated, each of the wireless audio receiving devices 100c1 to 100c3 may output a second sound, based on a second audio signal according to a second communication standard of a second frequency band received by the second communication module 135b. Accordingly, even when the wireless environment is complicated, it is possible to stably receive audio wirelessly and output sound.

Meanwhile, each of the wireless audio receiving devices 100c1 to 100c3 receives a beacon signal from a first wireless audio transmitting device 50a every period Pc corresponding to a first active period Pa and a first inactive period Pb, and searches for an additional device during the first inactive period Pb. In response to receiving a second beacon signal from a second wireless audio transmitting device 50b, each of the wireless audio receiving devices 100c1 to 100c3 transmits a connection request command to the second wireless audio transmitting device 50b, and based on the connection request command, additionally wirelessly connects to the second wireless audio transmitting device 50b based on ultra-wideband communication, during wireless connection with the first wireless audio transmitting device 50a based on ultra-wideband communication. Accordingly, it is possible to perform frequency hopping in ultra-wideband communication, by using a beacon signal.

Next, FIG. 1E illustrates a wireless audio system 10e according to another embodiment of the present disclosure.

Referring to FIG. 1E, a wireless audio system 10e according to another embodiment of the present disclosure may include a plurality of wireless audio receiving devices 100d1 and 100d2.

In particular, the wireless audio system 10e may include a plurality of wireless audio receiving devices 100d1 and 100d2, based on a unicast method.

For example, when a wireless audio signal is output from the first wireless audio receiving device 100d1, the wireless audio signal may be transmitted to the second wireless audio receiving device 100d2.

Accordingly, even when the wireless environment is complicated, it is possible to stably receive audio wirelessly and output sound.

Meanwhile, each of the wireless audio receiving devices 100d1 and 100d2 wirelessly outputs a first sound, based on a first audio signal according to a first communication standard of a first frequency band received by the first communication module 135a. In response to a packet error rate of the first audio signal is greater than or equal to a certain value as the wireless environment is complicated, each of the wireless audio receiving devices 100d1 and 100d2 may output a second sound, based on a second audio signal according to a second communication standard of a second frequency band received by the second communication module 135b. Accordingly, even when the wireless environment is complicated, it is possible to stably receive audio wirelessly and output sound.

Meanwhile, each of the wireless audio receiving devices 100d1 and 100d2 receives a beacon signal from a first wireless audio transmitting device 50a every period Pc corresponding to a first active period Pa and a first inactive period Pb, and searches for an additional device during the first inactive period Pb. In response to receiving a second beacon signal from a second wireless audio transmitting device 50b, each of the wireless audio receiving devices 100d1 and 100d2 transmits a connection request command to the second wireless audio transmitting device 50b, and based on the connection request command, additionally wirelessly connects to the second wireless audio transmitting device 50b based on ultra-wideband communication, during wireless connection with the first wireless audio transmitting device 50a based on ultra-wideband communication. Accordingly, it is possible to perform frequency hopping in ultra-wideband communication, by using a beacon signal.

Meanwhile, the wireless audio transmitting device 50 illustrated in FIGS. 1A to 1E may be a mobile terminal, a TV, a monitor, a tablet, a home appliance, a vehicle display device, and the like.

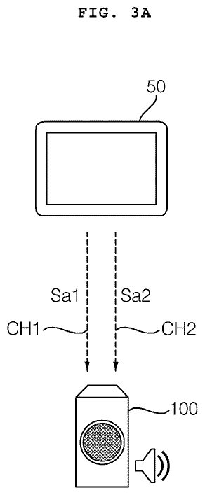

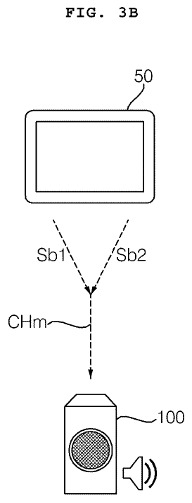

FIG. 2A is an example of an internal block diagram of the wireless audio receiving device of FIGS. 1A to 1E.

Referring to FIG. 2A, the wireless audio receiving device 100 may include a sensing device 130, a transceiver 135, a memory 140, a sound output device 160, a signal processing device 170, an input device 185, and a power supply 190. When these components are implemented in actual applications, if necessary, two or more components may be combined into one component, or one component may be subdivided into two or more components.

The sensing device 130 may include an inertial sensor 131. The inertial sensor may include an acceleration sensor, a gyro sensor, a gravity sensor, or the like. For example, the acceleration sensor, the gyro sensor, the gravity sensor, or the like may include a 6-axis sensor.

The sensing device 130 may output motion information of the wireless audio receiving device 100, for example, movement information (acceleration information, angular velocity information) or location information based on x, y, z axis.

Meanwhile, the sensing device 130 may include a sensor for obtaining user body information. For example, a blood pressure sensor, a brain wave sensor, or the like may be provided.

Meanwhile, the transceiver 135 may provide an interface for communication with an external device. To this end, the transceiver 135 may include at least one of a mobile communication module (not shown), a wireless Internet module (not shown), a short-distance communication module (not shown), or a GPS module (not shown).

For example, the transceiver 135 may perform IR communication, Bluetooth communication, or WiFi communication, thereby exchanging data with a paired wireless audio transmitting device 50 or transmitting data. In particular, it may receive an audio signal from the paired wireless audio transmitting device 50.

Meanwhile, the transceiver 135 may include a first communication module 135a that wirelessly receives a first audio signal according to a first communication standard of a first frequency band, and a second communication module 135b that wirelessly receives a second audio signal according to a second communication standard of a second frequency band greater than the first frequency band.

Meanwhile, the transceiver 135 may further include a processor 135c for signal processing or control of the first communication module 135a and the second communication module 135b.

Meanwhile, the first communication module 135a receives a first signal data through a first channel CH1, and separately receives a first audio data through a second channel CH2, and the second communication module 135b separately receives a second signal data and a second audio data through the same channel CHm.

Accordingly, even when the wireless environment is complicated, it is possible to stably receive audio wirelessly and output sound. In addition, signal data and audio data can be distinguished in the first communication module 135a and the second communication module 135b, so that audio can be stably received wirelessly and sound can be output.

Meanwhile, the beacon signal received by the second communication module 135b may include unicast information or broadcast information. Accordingly, it is possible to operate by dividing into unicast and broadcast.

Meanwhile, when unicast information is included in the received beacon signal, the second communication module 135b may transmit association request information to the wireless audio transmitting device 50 or 100, and may receive association response information from the wireless audio transmitting device 50 or 100. Accordingly, it is possible to operate by dividing into unicast and broadcast.

Meanwhile, the second communication module 135b may distinguish whether it is the second signal data or the second audio data, based on identification information in the header among the received second audio signal. Accordingly, signal data and audio data can be distinguished, thereby stably receiving audio wirelessly and outputting sound.

Meanwhile, the second communication module 135b may distinguish whether it is the second signal data or the second audio data, based on identification information in a media access control (MAC) header or a physical (PHY) header among the received second audio signal. Accordingly, signal data and audio data can be distinguished, thereby stably receiving audio wirelessly and outputting sound.

Meanwhile, in response to receiving the second signal data, the second communication module 135b may extract encoding or decoding information of the second standard, and based on the extracted encoding or decoding information, may receive the second audio data after the second signal data, and may set a replay time of the second audio data. Accordingly, signal data and audio data can be distinguished, thereby stably receiving audio wirelessly and outputting sound.

The memory 140 may store programs for processing or controlling the signal processing device 170 in the wireless audio receiving device 100, or may perform a function for temporarily storing input or output data.

The sound output device 160 may output an audio signal processed by the signal processing device 170 in the wireless audio receiving device 100.

Alternatively, the sound output device 160 may output guide information related to the operation of the wireless audio receiving device 100 as an audio signal.

Meanwhile, the sound output device 160 may output a first sound corresponding to the first audio signal from the first communication module 135a or a second sound corresponding to the second audio signal from the second communication module 135b.

The signal processing device 170 may control the overall operation of the wireless audio receiving device 100 by controlling the operation of each unit in the wireless audio receiving device 100.

Meanwhile, the signal processing device 170 may perform signal processing for an audio signal received from the outside.

Meanwhile, the signal processing device 170 may replay an audio signal from the first communication module 135a or the second communication module 135b.

Meanwhile, the signal processing device 170 may replay the second audio data, based on the decoding information from the second communication module 135b and a set replay time. Accordingly, signal data and audio data can be distinguished, thereby stably receiving audio wirelessly and outputting sound.

Meanwhile, the input device 185 may include a button for initializing the wireless audio receiving device 100, or inputting an operation.

Meanwhile, the input device 185 may include a microphone 187 for sound collection.

Meanwhile, the input device 185 may include a camera (not shown) for capturing images.

For example, as shown in FIG. 2A, the input device 185 may include a power key 185a for turning power on or off, a FF/REW key 185b for going forward or backward in the reproducing audio, a volume key 185c for volume up or down, pause/play key 185d for playing or pausing audio, and the like.

The power supply 190 may supply power required for operation of each component under the control of the signal processing device 170.

In particular, the power supply 190 may include a battery 195 that stores and outputs DC power.

FIG. 2B is an example of an internal block diagram of the wireless audio receiving device of FIGS. 1A to 1E.

Referring to FIG. 2A, the wireless audio transmitting device 50 may include a sensing device 130b, a transceiver 135b, a memory 140b, a sound output device 160b, a signal processing device 170b, a display 180b, an input device 185b, and a power supply 190b. When these components are implemented in actual applications, if necessary, two or more components may be combined into one component, or one component may be subdivided into two or more components.

The sensing device 130b may include an inertial sensor 131b. The inertial sensor may include an acceleration sensor, a gyro sensor, a gravity sensor, or the like. For example, the acceleration sensor, the gyro sensor, the gravity sensor, and the like may include a 6-axis sensor.

The sensing device 130b may output motion information of the wireless audio transmitting device 50, for example, movement information (acceleration information, angular velocity information) or location information based on x, y, z axis.

Meanwhile, the sensing device 130b may include a sensor for obtaining user body information. For example, a blood pressure sensor, a brain wave sensor, or the like may be provided.

Meanwhile, the transceiver 135b may provide an interface for communication with an external device. To this end, the transceiver 135b may include at least one of a mobile communication module (not shown), a wireless Internet module (not shown), a short-distance communication module (not shown), or a GPS module (not shown).

For example, the transceiver 135b may perform IR communication, Bluetooth communication, or WiFi communication, thereby exchanging data with a paired wireless audio receiving device 100 or transmitting data. In particular, it may transmit an audio signal to the paired wireless audio receiving device 100.

Meanwhile, the transceiver 135b may include a first communication module 135ab for wirelessly transmitting a first audio signal according to a first communication standard of a first frequency band, and a second communication module 135bb for wirelessly transmitting a second audio signal according to a second communication standard of a second frequency band (e.g. ultra-wideband) greater than the first frequency band.

Meanwhile, the second communication module 135bb may include a personal area network (PAN) coordinator PNb for ultra-wideband communication.

Meanwhile, the transceiver 135b may further include a processor 135cb for signal processing or control of the first communication module 135ab and the second communication module 135bb.

Meanwhile, the first communication module 135ab transmits a first signal data through a first channel CH1b, and separately transmits a first audio data through a second channel CH2, and the second communication module 135bb separately transmits a second signal data and a second audio data through the same channel CHm.

Accordingly, even when the wireless environment is complicated, it is possible to stably transmit an audio signal wirelessly. In addition, signal data and audio data can be distinguished in the first communication module 135ab and the second communication module 135bb, so that audio signals can be stably transmitted wirelessly.

Meanwhile, the beacon signal transmitted from the second communication module 135bb may include unicast information or broadcast information. Accordingly, it is possible to operate by dividing into unicast and broadcast.

Meanwhile, when unicast information is included in the transmitted beacon signal, the second communication module 135bb may receive association request information from the wireless audio receiving device 100, and transmit association response information to the wireless audio receiving device 100. Accordingly, it is possible to operate by dividing into unicast and broadcast.

Meanwhile, the second communication module 135bb may distinguish whether it is a second signal data or a second audio data, based on identification information in a header among the transmitted second audio signal. Accordingly, signal data and audio data can be distinguished, thereby stably transmitting an audio signal wirelessly.

Meanwhile, the second communication module 135bb may distinguish whether it is a second signal data or a second audio data, based on identification information in a media access control (MACb) header or a physical (PHYb) header among the transmitted second audio signal. Accordingly, signal data and audio data can be distinguished, thereby stably transmitting an audio signal wirelessly.

The memory 140b may store a program for processing or controlling the signal processing device 170b in the wireless audio transmitting device 50, or may perform a function for temporarily storing input or output data.

The sound output device 160b may output an audio signal processed by the signal processing device 170b in the wireless audio transmitting device 50.

Alternatively, the sound output device 160b may output guide information related to the operation of the wireless audio transmitting device 50 as an audio signal.

The signal processing device 170b may control the overall operation of the wireless audio transmitting device 50 by controlling the operation of each unit in the wireless audio transmitting device 50.

Meanwhile, the signal processing device 170b may perform signal processing for an audio signal received from the outside.

Meanwhile, the signal processing device 170b may control the operation of each unit, based on data from the first communication module 135ab or the second communication module 135bb.

The display 180b may include LCD, OLED, LED, micro LED, or the like.

Meanwhile, the input device 185b may include a button or the like for initializing or inputting an operation of the wireless audio transmitting device 50.

Meanwhile, the input device 185b may include a microphone 187b for sound collection.

Meanwhile, the input device 185b may include a camera (not shown) for capturing images.

For example, as shown in FIG. 2B, the input device 185b may include a power key (185ab) for turning power on or off, a FF/REW key (185bb) for going forward or backward in the reproducing audio, a volume key (185cb) for volume up or down, a pause/play key (185db) for playing or pausing audio, and the like.

The power supply 190b may supply power required for operation of each component under the control of the signal processing device 170b.

In particular, the power supply 190b may include a battery 195b that stores and outputs DC power.

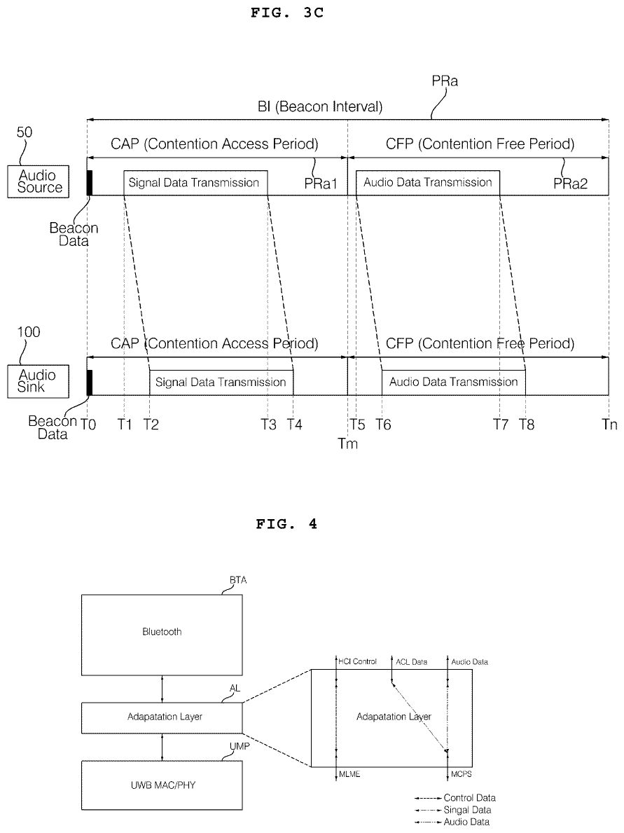

FIGS. 3A to 8B are diagrams for explaining an operation of a wireless audio receiving device or a wireless audio transmitting device according to an embodiment of the present disclosure.

FIG. 3A illustrates that the wireless audio transmitting device 50 outputs a first signal data Sa1 and a first audio data Sa2 to the wireless audio receiving device 100.

Referring to FIG. 3A, the wireless audio transmitting device 50 wirelessly outputs the first signal data Sa1 and the first audio data Sa2 according to a first communication standard of a first frequency band.

In particular, the wireless audio transmitting device 50 may transmit the first signal data Sa1 through the first channel CH1, and separately transmit the first audio data Sa2 through the second channel CH2.

Accordingly, the first communication module 135a in the wireless audio receiving device 100 according to an embodiment of the present disclosure receives the first signal data Sa1 through the first channel CH1, and distinguishes and receives the first audio data Sa2 through the second channel CH2.

FIG. 3B illustrates that the wireless audio transmitting device 50 outputs the second signal data Sb1 and the second audio data Sb2 to the wireless audio receiving device 100.

Referring to FIG. 3B, the wireless audio transmitting device 50 wirelessly outputs the second signal data Sb1 and the second audio data Sb2 according to a second communication standard of a second frequency band greater than the first frequency band.

In particular, the wireless audio transmitting device 50 may separately transmit the second signal data Sb1 and the second audio data Sb2 through the same channel CHm.

Accordingly, the second communication module 135b in the wireless audio receiving device 100 according to an embodiment of the present disclosure separately receives the second signal data Sb1 and the second audio data Sb2 through the same channel CHm.

Meanwhile, the first communication standard may be a Bluetooth communication standard, and the second communication standard may be an ultra-wideband (UWB) communication standard.

For example, the wireless audio transmitting device 50 may wirelessly transmit an audio signal according to the first communication standard, and then wirelessly transmit the audio signal according to the second communication standard when the wireless environment is complicated.

Accordingly, the wireless audio receiving device 100 may stably receive audio wirelessly and output sound even when the wireless environment is complicated. In addition, signal data and audio data can be distinguished in the first communication module 135a and the second communication module 135b, so that audio can be stably received wirelessly and sound can be output.

Meanwhile, the first communication module 135a according to an embodiment of the present disclosure may transmit the first signal data Sa1 through the first channel CH1, and separately transmit the first audio data Sa2 through the second channel CH2, and the second communication module 135b may separately transmit the second signal data Sb1 and the second audio data Sb2 through the same channel CHm. Accordingly, it is possible to stably transmit audio wirelessly even in a complicated wireless environment. In addition, signal data and audio data may be transmitted separately.

Meanwhile, the beacon signal transmitted from the second communication module 135b in the wireless audio transmitting device 50 may include unicast information or broadcast information. Accordingly, it is possible to operate by dividing into unicast and broadcast.

Meanwhile, when unicast information is included in the transmitted beacon signal, the second communication module 135b in the wireless audio transmitting device 50 may receive association request information from the wireless audio receiving device 100, and transmit association response information from an electronic device to the wireless audio receiving device 100. Accordingly, it is possible to operate by dividing into unicast and broadcast. In addition, it is possible to check whether ultra-wideband (UWB) wireless audio support is possible and transmit audio data wirelessly.

Meanwhile, the second communication module 135b in the wireless audio transmitting device 50 may add identification information in a media access control (MAC) header or a physical (PHY) header in order to distinguish whether the transmitted second audio signal is the second signal data Sb1 or the second audio data Sb2. Accordingly, it is possible to operate by dividing into unicast and broadcast.

Meanwhile, when the first communication module 135a in the wireless audio transmitting device 50 transmits the first audio signal and then the second communication module 135b transmits the second audio signal, Host Control Interface (HCI) data of the first communication standard may be mapped to MAC Layer Management Entity (MLME) interface of the second communication standard, and Asynchronous Connection-Less (ACL) data and audio data of the first communication standard may be mapped to a MAC Common Part Sublayer (MCPS) interface of the second communication standard. Accordingly, signal data and audio data can be distinguished, thereby stably transmitting audio wirelessly.

Meanwhile, when the first communication module 135a in the wireless audio transmitting device 50 transmits the first audio signal and then the second communication module 135b transmits the second audio signal, an adaptation layer (AL) may be used to map data of the first communication standard to data of the second communication standard. Accordingly, signal data and audio data can be distinguished, thereby stably transmitting audio wirelessly.

Meanwhile, when the second communication module 135b in the wireless audio transmitting device 50 transmits the second audio signal, it may transmit the second signal data Sb1 in a contention access period (CAP) of the beacon interval PRa, and may transmit the second audio data Sb2 in a contention free period (CFP) of the beacon interval PRa. Accordingly, signal data and audio data can be distinguished, thereby stably transmitting audio wirelessly.

Meanwhile, the first communication module 135a in the wireless audio transmitting device 50 may transmit the first signal data Sa1 and transmit identification information in the first signal data Sa1 to the second communication module 135b, and the second communication module 135b may separately transmit the second signal data Sb1 in the second audio signal, based on the identification information from the first communication module 135a. Accordingly, signal data and audio data can be distinguished, thereby stably transmitting audio wirelessly.

Meanwhile, the first communication module 135a in the wireless audio transmitting device 50 may transmit the first audio data Sa2 and transmit identification information in the first audio data Sa2 to the second communication module 135b, and the second communication module 135b may separately transmit the second audio data Sb2 in the second audio signal, based on the identification information from the first communication module 135a. Accordingly, signal data and audio data can be distinguished, thereby stably transmitting audio wirelessly.

Meanwhile, the second communication module 135b in the wireless audio transmitting device 50 may receive a security activation value from the wireless audio receiving device 100, and if it matches, generate a key, and encrypt and transmit the second audio data Sb2 by using the generated key. Accordingly, it is possible to stably transmit audio wirelessly based on security.

FIG. 3C is a diagram for explaining the operation of the wireless audio transmitting device 50 and the first communication module 135a of the wireless audio receiving device 100.

Referring to FIG. 3, the wireless audio transmitting device 50 may wirelessly transmit beacon data at time To during the beacon interval PRa, and the wireless audio receiving device 100 may wirelessly receive the beacon data.

Meanwhile, the wireless audio transmitting device 50 may transmit signal data in a contention access period (CAP) of the beacon interval PRa, and transmit audio data in a contention free period (CFP) of the beacon interval PRa.

In particular, FIG. 3 illustrates that signal data is transmitted between time T1 and time T3 within a contention access period (CAP), and audio data is transmitted between time T5 and time T7 within a contention free period (CFP).

In response, the wireless audio receiving device 100 may receive signal data between time T2 and time T4 within contention access period (CAP), and may receive audio data between time T6 and time T8 within a contention free period (CFP).

That is, when the second communication module in the wireless 135b audio receiving device 100 receives the second audio signal, it may receive the second signal data Sb1 in the contention access period (CAP) of the beacon interval PRa, and may receive the second audio data Sb2 in the contention free period (CFP) of the beacon interval PRa. Accordingly, signal data and audio data can be distinguished, thereby stably receiving audio wirelessly and outputting sound.

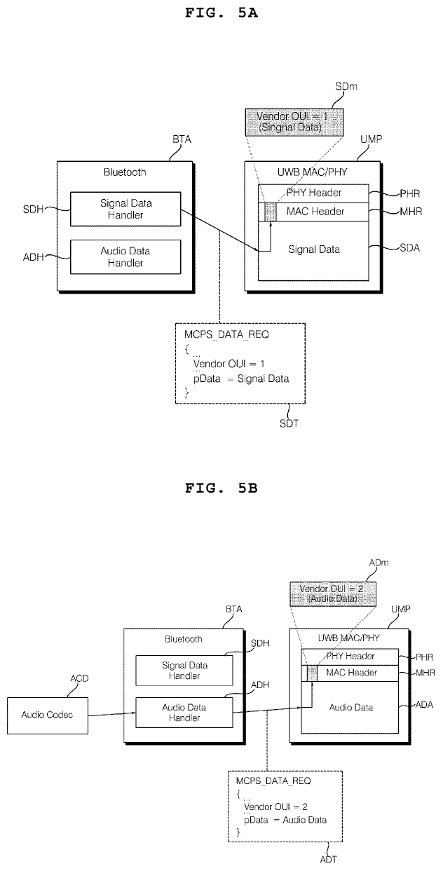

FIG. 4 is a diagram for explaining mapping between a first communication standard and a second communication standard.

Referring to FIG. 4, in order to provide a UWB audio service which is an example of the second communication standard, Bluetooth audio, which is an example of the first communication standard optimized for the audio service, is adopted as an upper protocol.

Bluetooth audio (BTA) interface is composed of HCI Control, ACL Data, and Audio Data.

Meanwhile, the Media access control or physical layer (MAC/PHY) (UMP) of UWB may have a MAC Layer Management Entity (MLME) interface and a MAC Common Part Sublayer (MCPS) interface.

Meanwhile, for mapping between Bluetooth audio (BTA) and UWB media access control or a physical layer (MAC/PHY) (UMP), an adaptation layer (AL) is utilized in an embodiment of the present disclosure.

In the adaptation layer (AL), Host Control Interface (HCI) data of the first communication standard may be mapped to MAC Layer Management Entity (MLME) interface of the second communication standard, and Asynchronous Connection-Less (ACL) data and audio data of the first communication standard may be mapped to a MAC Common Part Sublayer (MCPS) interface of the second communication standard.

Meanwhile, UWB wireless transmission or UWB wireless reception has a frequency band 3.1 GHz to 10.6 GHz different from the unlicensed band 2.4 GHz, thereby avoiding frequency interference with other wireless devices using the unlicensed band, and solving problems such as audio interruption.

In addition, since UWB wireless transmission or UWB wireless reception provides a higher PHY data rate than Bluetooth wireless transmission or wireless reception, high-quality audio service is possible.

Meanwhile, when the first communication module 135a receives the first audio signal and then the second communication module 135b receives the second audio signal, Host Control Interface (HCI) data of the first communication standard may be mapped to the MAC Layer Management Entity (MLME) interface of the second communication standard, and Asynchronous Connection-Less (ACL) data and audio data of the first communication standard may be mapped to the MAC Common Part Sublayer (MCPS) interface of the second communication standard. Accordingly, signal data and audio data can be distinguished, thereby stably receiving audio wirelessly and outputting sound.

Meanwhile, when the first communication module 135a receives the first audio signal and then the second communication module 135b receives the second audio signal, data of the first communication standard may be mapped to data of the second communication standard by using an adaptation layer AL. Accordingly, signal data and audio data can be distinguished, thereby stably receiving audio wirelessly and outputting sound.

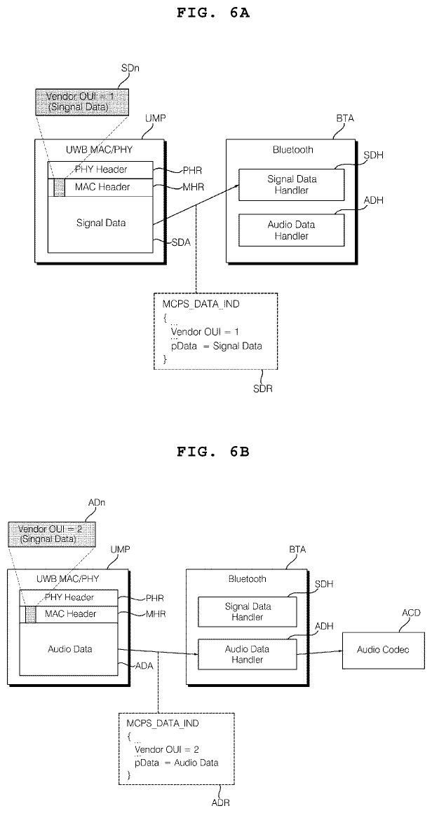

FIGS. 5A and 5B are diagrams for explaining an operation of a wireless audio transmitting device.

Referring to the drawing, the signal data handler SDH in the Bluetooth audio BTA of the wireless audio transmitting device 50 may define an identifier for distinguishing between signal data and audio data by using the Vendor OUI Field of the UWB MAC Header.

FIG. 5A illustrates signal data SDT when the Vendor OUI is ‘1’, and FIG. 5B illustrates audio data ADT when the Vendor OUI is ‘2’.

In particular, the Bluetooth audio BTA of the wireless audio transmitting device 50 may transmit signal data SDT for codec and QoS configuration used in the UWB audio service.

Meanwhile, when the wireless audio transmitting device 50 transmits the signal data SDT to the Media access control or physical layer (MAC/PHY) (UMP) of UWB, Vendor OUI, which is UWB MAC Header, may be set to ‘1’ and transmitted.

Meanwhile, in the wireless audio receiving device 100, when codec and QoS configuration are completed, audio data may be transmitted from the audio codec to Bluetooth audio BTA, and Bluetooth Audio BTA may be transmitted to the Media access control or physical layer (MAC/PHY) (UMP) of UWB by setting the Vendor OUI, which is UWB MAC Header, to ‘2’.

In addition, the wireless audio transmitting device 50 may transmit audio data to the wireless audio receiving device 100 with respect to Media access control or physical layer (MAC/PHY) (UMP) of UWB. Accordingly, even when the wireless environment is complicated, it is possible to stably receive audio wirelessly and output sound.

FIGS. 6A and 6B are diagrams for explaining an operation of a wireless audio receiving device.

Referring to the drawing, an identifier for distinguishing between signal data and audio data of Bluetooth audio (BTA) may be defined through the MCPS interface of the wireless audio receiving device 100.

FIG. 6A illustrates signal data SDR when the Vendor OUI is ‘1’, and FIG. 6B illustrates audio data ADR when the Vendor OUI is ‘2’.

When the Media access control or physical layer (MAC/PHY) (UMP) of UWB of the wireless audio receiving device 100 receives data having Vendor OUI, which is the UWB MAC Header, that is set to ‘1’, Bluetooth audio BTA may move to the signal data handler SDH.

In particular, the Bluetooth audio BTA of the wireless audio receiving device 100 may receive codec and QoS information used in the UWB audio service through a signal data handler SDH, and set information necessary for audio data reception.

Meanwhile, when the codec and QoS configuration for UWB audio service are completed, data whose Vendor OUI, which is the UWB MAC Header, is ‘2’ is received, and Bluetooth audio BTA may move to the audio data handler ADH.

The Bluetooth audio BTA sets a reproducing time for audio data received through an audio data handler (ADH), and the audio data having set reproducing time is transmitted to an audio codec. Accordingly, even when the wireless environment is complicated, it is possible to stably receive audio wirelessly and output sound.

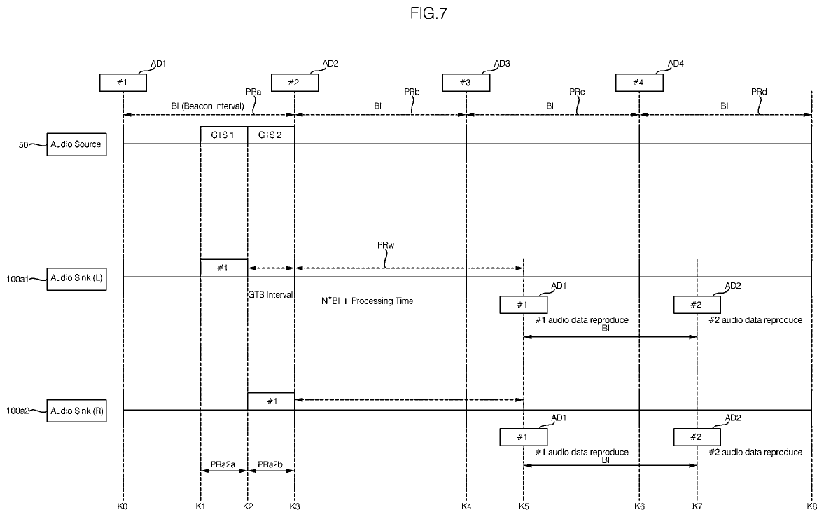

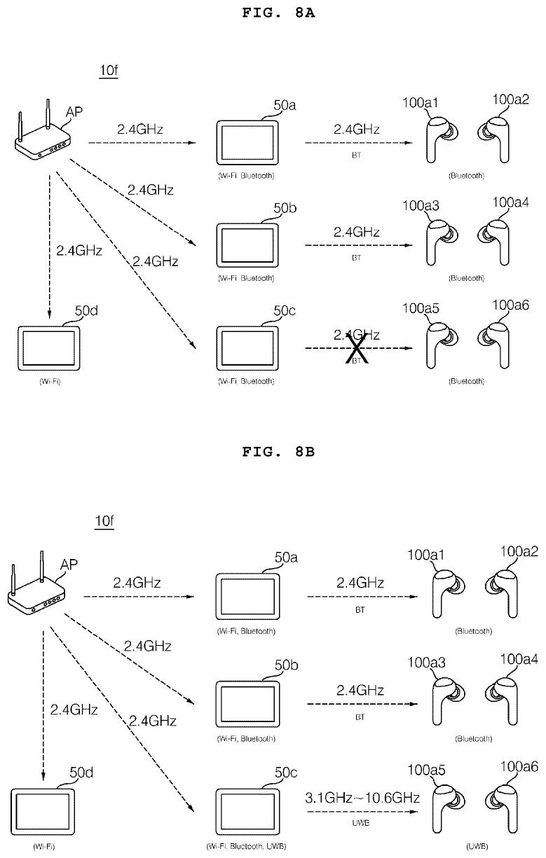

FIG. 7 is a diagram for explaining an UWB audio reproducing time synchronization.

Referring to FIG. 7, the wireless audio transmitting device 50 may sequentially transmit first to fourth audio data AD1 to AD4 to a plurality of wireless audio receiving devices 100a1 and 100a2 respectively.

In particular, the wireless audio transmitting device 50 may sequentially transmit the first to fourth audio data AD1 to AD4 for each channel in a beacon interval.

FIG. 7 illustrates that a first audio data AD1 is generated at time K0, transmitted to a first wireless audio receiving device 100al in an interval PRa2a between time K1 and time K2, and transmitted to a second wireless audio receiving device 100a2 in an interval PRa2b between time K2 and time K3.

Meanwhile, the interval PRa2a and the interval PRa2b may be set respectively by a plurality of wireless audio receiving devices 100al and 100a2 that receive audio data.

Similarly, at time K3, a second audio data AD2 is generated, and transmitted to the first wireless audio receiving device 100a1 and the second wireless audio receiving device 100a2, within a second beacon interval PRb.

Similarly, at time K4, a third audio data AD3 is generated, and transmitted to the first wireless audio receiving device 100al and the second wireless audio receiving device 100a2, within a third beacon interval PRc.

Similarly, at time K6, a fourth audio data AD4 is generated, and transmitted to the first wireless audio receiving device 100al and the second wireless audio receiving device 100a2, within a fourth beacon interval PRd.

Meanwhile, in order to synchronize and reproduce the first audio data AD1 received in a first beacon interval PRa in the plurality of wireless audio receiving devices 100a1 and 100a2, it is preferable that it is not reproduced in a second beacon interval PRb, but reproduced at the time K5 in the third beacon interval PRc.

That is, after audio data is reproduced, it is preferable that it is reproduced not in the next beacon interval but in the beacon interval after next.

Meanwhile, it is preferable that the interval PRw from the audio data reception completion time K3 to the reproducing start point K5 is greater than the length of the beacon interval. Accordingly, it is possible to stably synchronize and reproduce audio data.

Meanwhile, after the first audio data AD1 is reproduced at the time K5, it is preferable that the second audio data AD2 is spaced apart by the beacon interval and reproduced at the time K7. Accordingly, it is possible to stably synchronize and reproduce audio data.

FIGS. 8A and 8B illustrate a wireless audio system 10f including an AP device (AP), a plurality of wireless audio transmitting devices 50a to 50d, and a plurality of wireless audio receiving devices 100al to 100a6.

As shown in FIG. 8A, in a complicated wireless environment, between the plurality of wireless audio transmitting devices 50a to 50d and the plurality of wireless audio receiving devices 100a1 to 100a6, when audio is transmitted wirelessly by using Bluetooth communication which is the same first communication standard, audio data transmission becomes impossible due to frequency interference.

FIG. 8A illustrates that audio data transmission is impossible due to frequency interference, between a third wireless audio transmitting device 50c and the plurality of wireless audio receiving devices 100a5 to 100a6.

In order to solve this problem, an embodiment of the present disclosure utilizes a second communication standard having a larger frequency band and a larger bandwidth than the first communication standard. The second communication standard may be UWB.

As shown in FIG. 8B, in a complicated wireless environment, it is preferable that among a plurality of wireless audio transmitting devices 50a to 50d and a plurality of wireless audio receiving devices 100al to 100a6, devices excluding the third wireless audio transmitting device 50c and the plurality of wireless audio receiving devices 100a5 to 100a6 use Bluetooth communication which is the first communication standard, and the third wireless audio transmitting device 50c and the plurality of wireless audio receiving devices 100a5 to 100a6 use UWB communication. Accordingly, it is possible to stably transmit and receive wireless audio data even in a complicated wireless environment.

Meanwhile, since ultra-wideband UWB communication has characteristics of low frequency congestion and resistance to interference, it may be suitable in a complicated wireless environment.

Accordingly, UWB communication is used to detect indoor positioning, but in the present disclosure, it is assumed to be used for audio service.

Meanwhile, UWB communication may be provided in standard specifications such as IEEE 802.15.4.

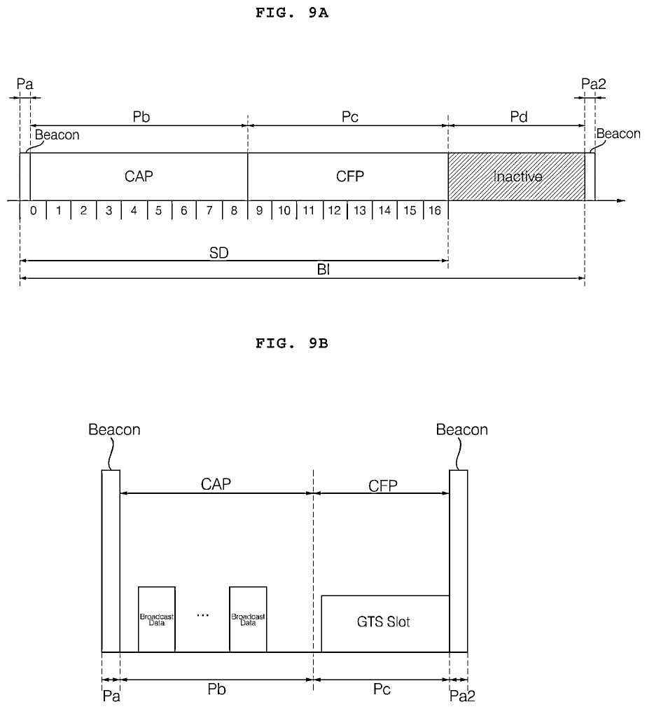

FIG. 9A is a diagram illustrating a beacon interval in ultra-wideband communication.

As shown in FIG. 9A, according to the IEEE 802.15.4 standard for ultra-wideband (UWB) communication, the beacon interval BI includes a first period Pa configured to transmit a beacon signal (Beacon), a second period Pb corresponding to a contention access period CAP, a third period Pc corresponding to a contention free period CFP, and an inactive period Pd.

Meanwhile, an active period includes a first period Pa, a second period Pb, and a third period Pc, and the active period may be referred to as a superframe duration SD.

Meanwhile, after the end of the beacon interval BI, the first period Pa2 configured to transmit the beacon signal (Beacon) is disposed again in an additional beacon interval BI.

The wireless audio transmitting device 50 may transmit audio data to the wireless audio receiving device 100, by using the beacon interval BI of FIG. 9A through ultra-wideband communication.

Meanwhile, the wireless audio receiving device 100 may receive audio data from the wireless audio receiving device 100, by using the beacon interval BI of FIG. 9A through ultra-wideband communication.

Meanwhile, in the inactive period rather than the active period, the wireless audio transmitting device 50 and the wireless audio receiving device 100 operate with a low power.

FIG. 9B is a diagram for explaining FIG. 9A.

Referring to the drawing, FIG. 9B is similar to FIG. 9A, but shows only an active period in the beacon interval BI.

The beacon interval BI includes a first period Pa configured to transmit a beacon signal (Beacon), a second period Pb corresponding to a contention access period CAP, and a third period Pc corresponding to a contention free period CFP.

Meanwhile, the second period Pb corresponds to a period configured to transmit broadcast data.

Meanwhile, the third period Pc is a period for unicast data transmission, and includes a guaranteed time slot.

According to communication standards, in order for the wireless audio transmitting device 50 to transmit unicast audio data in a unicast method, the wireless audio receiving device 100 must be connected to the wireless audio transmitting device 50.

Meanwhile, in order for the wireless audio transmitting device 50 to transmit unicast audio data in a unicast method, a PAN coordinator PNb in the transceiver 135b inside the wireless audio transmitting device 50 assigns a guaranteed time slot GTS, and transmits information related to the assigned guaranteed time slot GTS to the wireless audio receiving device 100.

In response to this, the wireless audio receiving device 100 receives unicast audio data through the guaranteed time slot GTS in the third period Pc, based on the information related to the assigned guaranteed time slot GTS.

Meanwhile, according to communication standards, in order for the wireless audio transmitting device 50 to transmit broadcast audio data, a plurality of wireless audio receiving devices 100 must be connected to the wireless audio transmitting device 50.

Meanwhile, in order to transmit broadcast audio data to a plurality of wireless audio receiving devices, the PAN coordinator PNb in the transceiver 135b inside the wireless audio transmitting device 50 checks an empty period during a contention access period in the second period Pb, and assigns and transmits broadcast audio data in the empty period.

According to this method, transmission time of broadcast audio data cannot be guaranteed due to interference of neighboring signals.

In addition, since the wireless audio receiving device 100 does not know when the broadcast audio data will be received, it needs to monitor all contention access periods within the second period Pb. Accordingly, there is a disadvantage in that power consumption is significant.

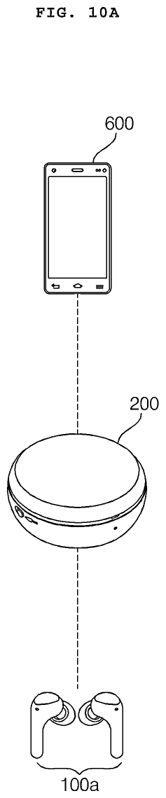

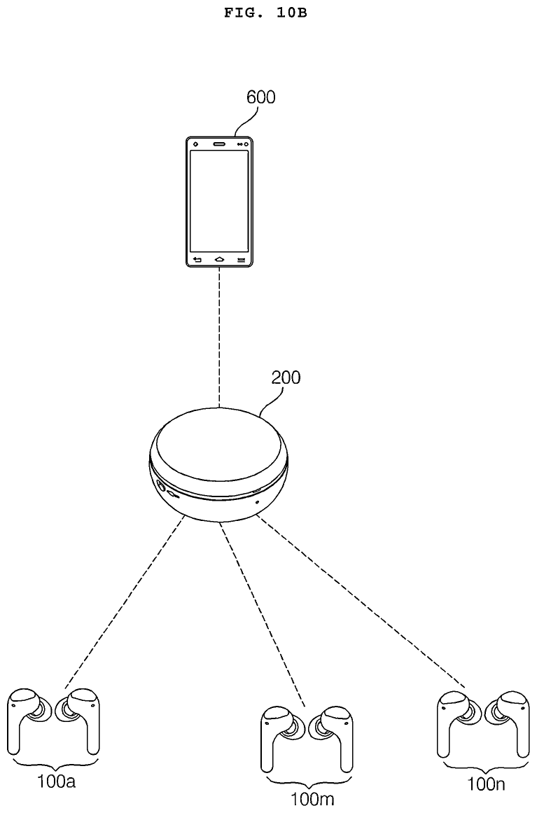

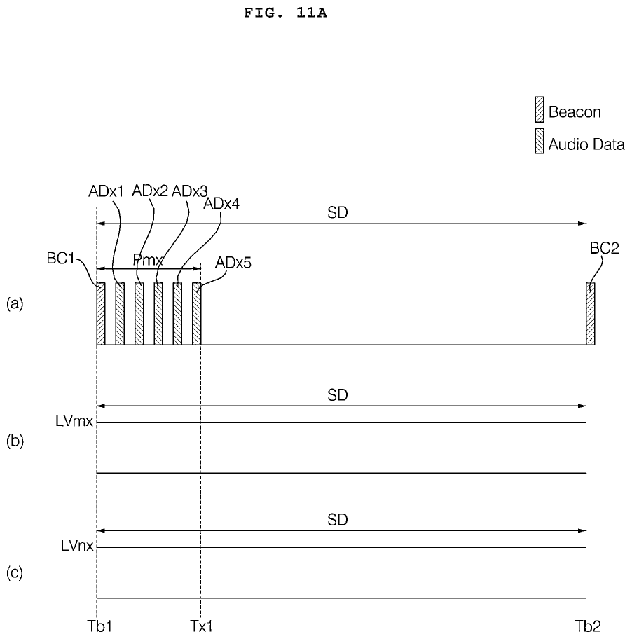

Accordingly, in the present disclosure, a method for sharing audio data in ultra-wideband communication with broadcast audio data in a simple and rapid manner is proposed. This will be described with reference to FIG. 10A and below.

FIG. 10A is a diagram illustrating an example of an audio exclusive transmission mode in ultra-wideband communication.

Referring to FIG. 10A, in an audio exclusive transmission mode in ultra-wideband communication, a mobile terminal 600 may transmit unicast audio data to the wireless audio receiving device 100a.

At this time, the mobile terminal 600 may transmit the unicast audio data to a cradle device 200 that can charge the wireless audio receiving device 100a by placing it therein, and the cradle device 200 may transmit the unicast audio data to the wireless audio receiving device 100a.

At this time, ultra-wideband communication may be performed between the cradle device 200 and the wireless audio receiving device 100a.

Meanwhile, the mobile terminal 600 and the cradle device 200 may exchange audio data through ultra-wideband communication or other communication method.

FIG. 10B is a diagram illustrating an example of an audio sharing mode in ultra-wideband communication.

Referring to FIG. 10B, in an audio sharing mode in ultra-wideband communication, the mobile terminal 600 may transmit broadcast audio data to a plurality of wireless audio receiving devices 100a, 100m, and 100n.

At this time, the mobile terminal 600 may transmit audio data to a cradle device 200 that can charge the first wireless audio receiving device 100a, among the plurality of wireless audio receiving devices 100a, 100m, and 100n, by placing it therein, and the cradle device 200 may transmit the broadcast audio data to the plurality of wireless audio receiving devices 100a, 100m, and 100n.

At this time, ultra-wideband communication may be performed between the cradle device 200 and the plurality of wireless audio receiving devices 100a, 100m, and 100n.

Meanwhile, the mobile terminal 600 and the cradle device 200 may exchange audio data through ultra-wideband communication or other communication method.

At this time, the audio data transmitted between the mobile terminal 600 and the cradle device 200 may be unicast audio data or broadcast audio data.

For example, when the audio data transmitted between the mobile terminal 600 and the cradle device 200 is unicast audio data, the audio sharing mode may be executed by the cradle device 200, not the mobile terminal 600.

As another example, when the audio data transmitted between the mobile terminal 600 and the cradle device 200 is broadcast audio data, the audio sharing mode may be executed by the cradle device 200 as well as the mobile terminal 600.

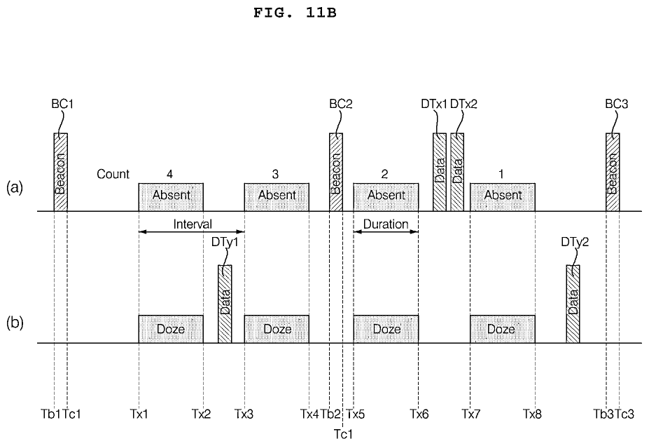

FIGS. 11A and 11B are diagrams illustrating various examples of wireless data transmission methods related to the present disclosure.

FIG. 11A illustrates an example of a wireless data transmission method related to the present disclosure.

Referring to FIG. 11A, the wireless data transmitting device and a wireless data receiving device may transmit audio data through ultra-wideband communication.

For example, the wireless data transmitting device related to the present disclosure may periodically transmit a beacon signal.

In FIG. 11A, it is illustrated that after a first beacon signal BC1 at time point Tb1, a second beacon signal BC2 is transmitted at time point Tb2, and the interval between the first beacon signal BC1 and the second beacon signal BC2 is SD.

Meanwhile, the wireless data transmitting device related to the present disclosure may sequentially transmit a plurality of wireless audio data (ARx1 to ARx5), after transmission of the first beacon signal BC1, as shown in FIG. 11A(a).

In FIG. 11A(a), a plurality of wireless audio data (ARx1 to ARx5) are sequentially transmitted during a period Pmx from the time point Tb1 to Tx1.

Meanwhile, as shown in FIG. 11A(b), after the first beacon signal BC1, the wireless audio receiving is configured to operate in a first level LVmx, which is a high level, to receive wireless audio data ARx1 to ARx5, etc.

To this end, the power supply in the wireless audio receiving device of FIG. 11A must supply high-level LVnx power to a communication device in the wireless audio receiving device. Thus, there occurs significant power consumption.

FIG. 11B shows another example of a wireless data transmission method related to the present disclosure.

Referring to FIG. 11B, a wireless data transmitting device and a wireless data receiving device may transmit audio data through Wi-Fi Direct communication.

For example, the wireless data transmitting device related to the present disclosure may periodically transmit a beacon signal.

FIG. 11B illustrates that after the first beacon signal BC1 between the time point Tb1 and the time point Tc1, the second beacon signal BC2 is transmitted between the time point Tb2 and the time point Tc2, and after the second beacon signal BC2, the third beacon signal BC3 is transmitted between the time point Tb3 and the time point Tc31.

Meanwhile, the wireless data transmitting device of FIG. 11B may transmit notice of absence (NOA) information when transmitting a beacon signal such as the first beacon signal BC1.

At this time, NOA information may include count information, interval information, duration information, etc.

Meanwhile, according to Wi-Fi Direct communication, as shown in FIG. 11B(a), it is divided into a period for data transmission or reception and a period (Absent) in which data cannot be transmitted or received.

FIG. 11B(a) illustrate a section between Tx1 and Tx2, a section between Tx3 and Tx4, a section between Tx5 and Tx6, and a section between Tx7 and Tx8 as a period in which data cannot be transmitted or received.

Meanwhile, FIG. 11B(a) illustrate a section between Tx2 and Tx3, a section between Tx6 and Tx7, etc as a period for data transmission or reception.

In particular, during the section between Tx6 and Tx7, the wireless data transmitting device may transmit data (DTx1, DTx2), and during the section between Tx2 and Tx3, the wireless data receiving device may transmit data DTy1.

Accordingly, the wireless data receiving device may reduce power consumption by entering a standby state, etc. in a dose period, as shown in FIG. 11B(b).

However, according to Wi-Fi Direct communication, data is transmitted only in a preset data transmission or reception period. Accordingly, there is a disadvantage in services such as real-time audio data transmission.

In particular, as shown in the drawing, since the period for data transmission or reception is significantly smaller than the period (Absent) in which data cannot be transmitted or received, real-time data transmission or reception may not be smooth.

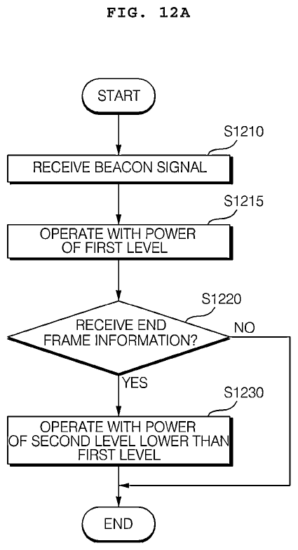

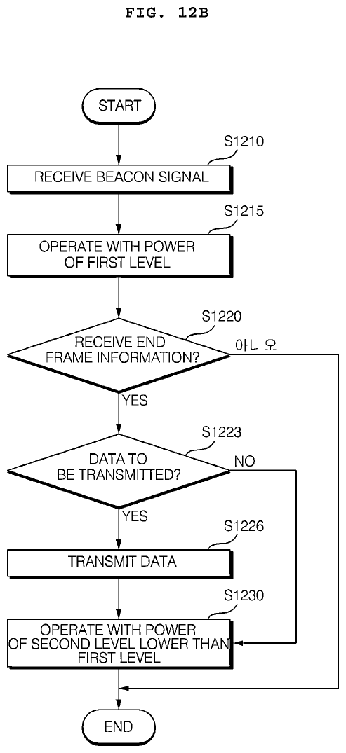

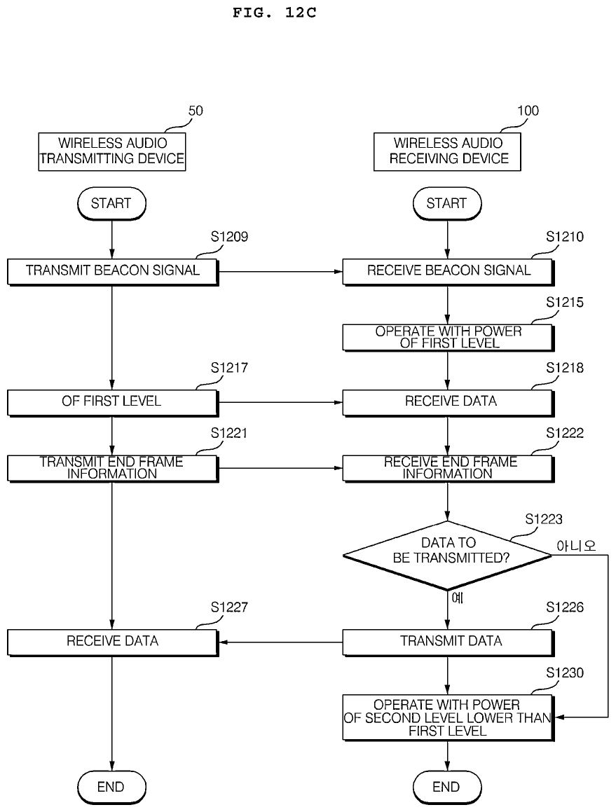

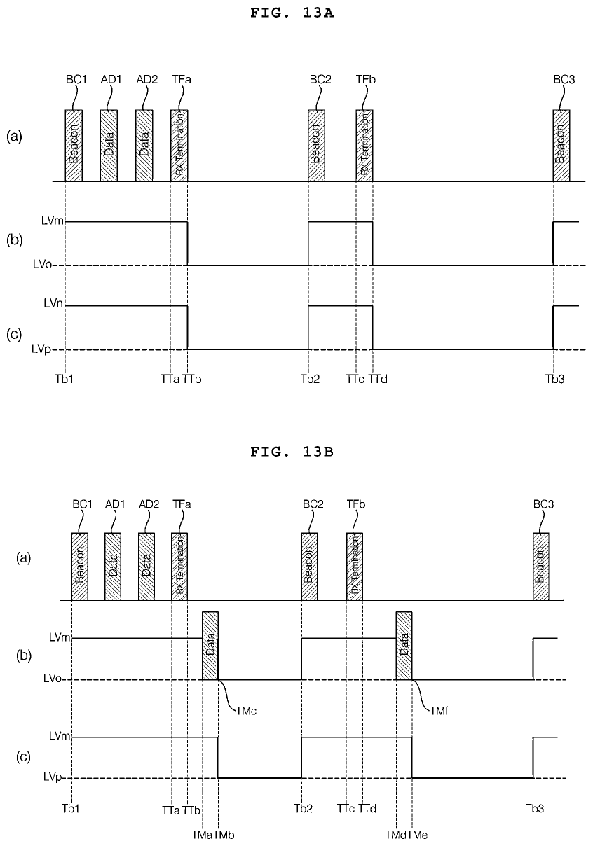

Accordingly, this disclosure proposes a method for stably receiving transmitting wireless audio data while reducing power consumption during ultra-wideband communication. This will be described with reference to FIG. 12A and below.

FIG. 12A is a flowchart showing a method of operating a wireless audio receiving device according to an embodiment of the present disclosure.

Referring to FIG. 12A, the transceiver 135 in the wireless audio receiving device 100 according to an embodiment of the present disclosure receives a beacon signal from the wireless audio transmitting device 50 through ultra-wideband communication (S1210).

Meanwhile, the transceiver 135 in the wireless audio receiving device 100 may periodically receive a beacon signal from the wireless audio transmitting device 50.

Meanwhile, the transceiver 135 in the wireless audio receiving device 100 operates based on the power of a first level LVm after receiving the beacon signal (S1215).

Meanwhile, the transceiver 135 in the wireless audio receiving device 100 may receive wireless audio data, etc. during operation based on the power of the first level LVm.

Meanwhile, the transceiver 135 in the wireless determines whether to audio receiving device 100 receive end frame information from the wireless audio transmitting device 50 during operation based on the power of the first level LVm (S1220), and if applicable, operates with power of a second level LVo lower than the first level LVm or turn off (S1230). Accordingly, power consumption during ultra-wideband communication can be reduced. Furthermore, wireless audio data can be received stably.

Meanwhile, after receiving the beacon signal, in response to receiving data while operating based on the power of the first level LVm, and then receiving end frame information, the transceiver 135 may operate based on a power of the second level LVo lower than the first level LVm or may be turned off, after the time of receiving the end frame information until receiving the next beacon signal. Accordingly, power consumption during ultra-wideband communication can be reduced. In particular, power consumption can be reduced, after the time of receiving the end frame information.

FIG. 12B is a flowchart showing a method of operating a wireless audio receiving device according to another embodiment of the present disclosure.

Referring to FIG. 12B, the transceiver 135 in the wireless audio receiving device 100 according to another embodiment of the present disclosure receives a beacon signal from the wireless audio transmitting device 50 through ultra-wideband communication (S1210).

Next, the transceiver 135 in the wireless audio receiving device 100 operates based on the power of the first level LVm, after receiving the beacon signal (S1215).

Meanwhile, the transceiver 135 in the wireless audio receiving device 100 may receive wireless audio data, etc. during operation based on the power of the first level LVm.

Meanwhile, the transceiver 135 in the wireless audio receiving device 100 determines whether to receive end frame information from the wireless audio transmitting device 50 during operation based on the power of the first level LVm (S1220), and if applicable, determines whether there exists transmission data to be transmitted (S1223), and if applicable, transmits the transmission data (S1226).

Next, the transceiver 135 in the wireless audio receiving device 100 operates based on a power of the second level LVo lower than the first level LVm or turn off, after transmitting the transmission data (S1230). Accordingly, power consumption during ultra-wideband communication can be reduced. Furthermore, wireless audio data can be received stably.

Meanwhile, at step S1223, if there is no transmission data to be transmitted, the transceiver 135 operates based on the power of the second level LVo or turn off, after receiving the end frame information until receiving the next beacon signal. Accordingly, power consumption during ultra-wideband communication can be reduced.

FIG. 12C is a flowchart showing a method of operating a wireless audio system according to an embodiment of the present disclosure.

Referring to FIG. 12C, the transceiver 135b in the wireless audio transmitting device 50 in the wireless audio system 10 according to an embodiment of the present disclosure transmits a beacon signal through ultra-wideband communication (S1209).

Correspondingly, the transceiver 135 in the wireless audio receiving device 100 receives a beacon signal from the wireless audio transmitting device 50 through ultra-wideband communication (S1210).

Next, the transceiver 135 in the wireless audio receiving device 100 operates based on the power of the first level LVm, after receiving the beacon signal (S1215).

Next, the transceiver 135b in the wireless audio transmitting device 50 may transmit wireless audio data through ultra-wideband communication (S1217).

Correspondingly, the transceiver 135 in the wireless audio receiving device 100 may receive wireless audio data, etc. during operation based on the power of the first level LVm (S1218).

In addition, the sound output device 160 in the wireless audio receiving device 100 may output sound corresponding to the received wireless audio data.

Meanwhile, the transceiver 135b in the wireless audio transmitting device 50 may transmit the end frame information in response to no more wireless audio data to be transmitted, after transmission of the wireless audio data (S1221).

Correspondingly, the transceiver 135 in the wireless audio receiving device 100 may receive the end frame information from the wireless audio transmitting device 50 during operation based on the power of the first level LVm (S1220).

Next, after receiving the end frame information, the transceiver 135 in the wireless audio receiving device 100 determines whether there is transmission data to be transmitted (S1223) and, if applicable, transmits the transmission data to the wireless audio transmitting device 50 (S1226).

Correspondingly, the transceiver 135b in the wireless audio transmitting device 50 may receive data from the wireless audio receiving device 100 (S1227).

The data, in this case, may be response data corresponding to wireless audio data, etc. In particular, the response data may include information related to success or failure in receiving wireless audio data.

The transceiver 135b in the wireless audio transmitting device 50 may determine whether wireless audio data transmission is successful or failed, based on reception of this response data.

Next, the transceiver 135 in the wireless audio receiving device 100 operates based on the power of the second level LVo lower than the first level LVm or turn off, after transmitting the transmission data (S1230). Accordingly, power consumption during ultra-wideband communication may be reduced. Furthermore, wireless audio data may be received stably.

Meanwhile, at step S1223, if there is no transmission data to be transmitted, the transceiver 135 operates with power of the second level LVo or turn off, after receiving the end frame information until receiving the next beacon signal. Accordingly, power consumption during ultra-wideband communication may be reduced.

FIGS. 13A to 15 are diagrams for explaining FIGS. 12A to 12C.

FIG. 13A illustrates an example of the operation of the wireless audio receiving device 100.

Referring to FIG. 13A, the transceiver 135 in the wireless audio receiving device 100 periodically receives a beacon signal through ultra-wideband communication.

FIG. 13A illustrates that the transceiver 135 in the wireless audio receiving device 100 receives first beacon signal BC1, a second beacon signal BC2, and a third beacon signal BC3 at time points Tb1, Tb2, and Tb3, respectively.

In response to receiving the first beacon signal BC1, the transceiver 135 in the wireless audio receiving device 100 operates based on the power of the first level LVm.

Meanwhile, after receiving the first beacon signal BC1, in response to receiving the end frame information TFa from the wireless audio transmitting device 50 between the TTa time point and the TTb time point, it operates based on the power of the second level LVo lower than the first level LVm or turn off.

For example, in response to no transmission data to be transmitted to the wireless audio transmitting device 50, after receiving the end frame information TFa until receiving the second beacon signal BC2 following the first beacon signal BC1, the transceiver 135 in the wireless audio receiving device 100 may be operated based on the power of the second level LVo or be turned off. Accordingly, power consumption during ultra-wideband communication may be reduced.

In the drawing, the transceiver 135 in the wireless audio receiving device 100 operates based on the power of the second level LVo or turn off, during the period between time point TTb and time point Tb2. Accordingly, the power consumption during ultra-wideband communication may be reduced. In particular, the power consumption may be reduced during the period between time point TTb and time point Tb2.

Meanwhile, the transceiver 135 in the wireless audio receiving device 100 receives the wireless audio data AD1, AD2 after receiving the first beacon signal BC1, and then receives the end frame information TFa. In response to no transmission data to be transmitted to the wireless audio transmitting device 50, the transceiver 135 in the wireless audio receiving device 100 may be operated based on the power of the second level LVo or turned off, after receiving the end frame information TFa until receiving the second beacon signal BC2 following the first beacon signal BC1. Accordingly, power consumption during ultra-wideband communication may be reduced.

Meanwhile, when the transceiver 135 receives the first beacon signal BC1, the power supply 190 in the wireless audio receiving device 100 supplies power of the third level LVn, as shown in FIG. 13A(c). In addition, when the transceiver 135 receives the end frame information TFa from the wireless audio transmitting device 50 after receiving the first beacon signal BC1, the power supply 190 may supply the power of a fourth level LVp lower than the third level LVn. Accordingly, power consumption during ultra-wideband communication may be reduced.

Meanwhile, in response to receiving the second beacon signal BC2, the transceiver 135 in the wireless audio receiving device 100 operates based on the power of the first level LVm which is a higher level than the second level LVo.

Meanwhile, after receiving the second beacon signal BC2, in response to receiving the end frame information TFb from the wireless audio transmitting device 50, at between the time point TTc and the time point TTd, it operates based on the power of the second level LVo lower than the first level LVm or turn off.

For example, in response to no transmission data to be transmitted to the wireless audio transmitting device 50, the transceiver 135 in the wireless audio receiving device 100 may be operated based on the power of the second level LVo or turned off, after receiving the end frame information TFb until receiving the third beacon signal BC3 following the second beacon signal BC2. Accordingly, power consumption during ultra-wideband communication may be reduced.

In the drawing, it is illustrated that the transceiver 135 in the wireless audio receiving device 100 operates based on the power of the second level LVo or turn off, during the period between time point TTd and time point Tb3. Accordingly, power consumption during ultra-wideband communication may be reduced. In particular, power consumption may be reduced during the period between time point TTd and time point Tb3.

Meanwhile, after receiving the second beacon signal BC2, the transceiver 135 in the wireless audio receiving device 100 receives the end frame information TFb in a state in which wireless audio data is not received. In addition, if there is no transmission data to be transmitted to the audio transmission device 50, the transceiver 135 in the wireless audio receiving device 100 may be operated based on the power of the second level LVo or turned off, after the time of receiving the end frame information TFb until receiving the third beacon signal BC3 following the second beacon signal BC2. Accordingly, power consumption during ultra-wideband communication may be reduced.

Meanwhile, when the transceiver 135 receives the second beacon signal BC2, the power supply 190 in the wireless audio receiving device 100 supplies the power of the third level LVn, as shown in FIG. 13A(c). In addition, when the transceiver 135 receives the second beacon signal BC2, the power supply 190 in the wireless audio receiving device 100 may supply the fourth level LVp lower than the third level LVn, after receiving the second beacon signal BC2. Accordingly, power consumption during ultra-wideband communication may be reduced.

Meanwhile, if wireless audio data is not received after the time of receiving the second beacon signal BC2, the period between the time point TTd and the time point Tb3 may be longer than the period between the time point TTb and the time point Tb2 after the wireless audio data is received.

Accordingly, the reduction in power consumption when wireless audio data is not received may be greater than when wireless audio data is received.

FIG. 13B illustrates another example of the operation of the wireless audio receiving device 100.

Referring to FIG. 13B, the transceiver 135 in the wireless audio receiving device 100 operates similarly to FIG. 13A, but there is a difference in that transmission data is transmitted after receiving the end frame information.

The transceiver 135 in the wireless audio receiving device 100 periodically receives the first beacon signal BC1, the second beacon signal BC2, and the third beacon signal BC3 at the time points Tb1, Tb2, and Tb3, respectively, through the ultra-wideband communication.

In response to receiving the first beacon signal BC1, the transceiver 135 in the wireless audio receiving device 100 operates based on the power of the first level LVm.

Meanwhile, the transceiver 135 in the wireless audio receiving device 100 may receive the end frame information TFa from the wireless audio transmitting device 50, at between the time point TTa and the time point TTb, after receiving the first beacon signal BC1.

Meanwhile, in response to transmission data TMc to be transmitted to the wireless audio transmitting device 50, the transceiver 135 in the wireless audio receiving device 100 transmits the transmission data TMc, during operation based on the power of the first level LVm, after receiving the end frame information TFa.

FIG. 13B illustrates that the transceiver 135 in the wireless audio receiving device 100 transmits the transmission data TMc during the period between the time point TMa and the time point TMb.

Next, the transceiver 135 in the wireless audio receiving device 100 may be operated based on the power of the second level LVo or turned off, after the time of transmitting the transmission data TMc until receiving the second beacon signal BC2 following the first beacon signal BC1. Accordingly, the power consumption during ultra-wideband communication may be reduced.

In the drawing, it is illustrated that the transceiver 135 in the wireless audio receiving device 100 may be operated based on the power of the second level LVo or turned off, during the period between the time point TMb and the time point Tb2. Accordingly, the power consumption during ultra-wideband communication may be reduced. In particular, the power consumption may be reduced during the period between the time point TMb and the time point Tb2.

Meanwhile, the transceiver 135 in the wireless audio receiving device 100 receives the first beacon signal BC1, then receives the wireless audio data AD1, AD2, and then receives the end frame information TFa. If there is transmission data to be transmitted to the wireless audio transmitting device 50, the transceiver 135 in the wireless audio receiving device 100 may transmit the transmission data TMc, and may be operated based on the power of the second level LVo or turned off, after the time of transmitting the transmission data TMc until receiving the second beacon signal BC2 following the first beacon signal BC1. Accordingly, the power consumption during ultra-wideband communication may be reduced.

Meanwhile, when the transceiver 135 receives the first beacon signal BC1, the power supply 190 in the wireless audio receiving device 100 supplies the power of the third level LVn, as shown in FIG. 13A(c). Further, when the transceiver 135 receives the end frame information TFa from the wireless audio transmitting device 50 and transmits the transmission data TMc, after receiving the first beacon signal BC1, the power supply 190 in the wireless audio receiving device 100 may supply the power of the fourth level LVp lower than the third level LVn after transmitting the transmission data TMC. Accordingly, the power consumption during ultra-wideband communication may be reduced.

Meanwhile, in response to receiving the second beacon signal BC2, the transceiver 135 in the wireless audio receiving device 100 operates based on the power of the first level LVm which is a higher level than the second level LVo.

Meanwhile, after receiving the second beacon signal BC2, in response to receiving the end frame information TFb from the wireless audio transmitting device 50 at between the time point TTc and the time point TTd, the transceiver 135 in the wireless audio receiving device 100 operates based on the power of the second level lower than the first level LVm or turn off.

For example, in response to transmission data to be transmitted to the wireless audio transmitting device 50, the transceiver 135 in the wireless audio receiving device 100 transmits the transmission data TMf, and may be operated based on the power of the second level LVo or turned off, after the time of transmitting the transmission data TMf until receiving the third beacon signal BC3 following the second beacon signal BC2. Accordingly, the power consumption during ultra-wideband communication may be reduced.

In the drawing, it is illustrated that the transceiver 135 in the wireless audio receiving device 100 operates based on the power of the second level LVo or turn off, during the period between the time point TMe and the time point Tb3. Accordingly, the power consumption during ultra-wideband communication may be reduced. In particular, the power consumption may be reduced during the period between the time point TMe and the time point Tb3.

Meanwhile, after receiving the second beacon signal BC2, the transceiver 135 in the wireless audio receiving device 100 receives the end frame information TFb in a state in which wireless audio data is not and if there is transmission data to be received, transmitted audio transmission device 50, transmits the transmission data TMf, may be operated based on the power of the second level LVo or turned off, after the time of transmitting the transmission data TMf until receiving the third beacon signal BC3 following the second beacon signal BC2. Accordingly, the power consumption during ultra-wideband communication may be reduced.

Meanwhile, when the transceiver 135 receives the second beacon signal BC2, the power supply 190 in the wireless audio receiving device 100 supplies the power of the third level LVn, as shown in FIG. 13A(c). After the transceiver 135 receives the second beacon signal BC2, after the time of transmitting the transmission data TMf until receiving the third beacon signal BC3 following the second beacon signal BC2, the power supply 190 in the wireless audio receiving device 100 may supply the power of the fourth level LVp lower than the third level LVn. Accordingly, the power consumption during ultra-wideband communication may be reduced.

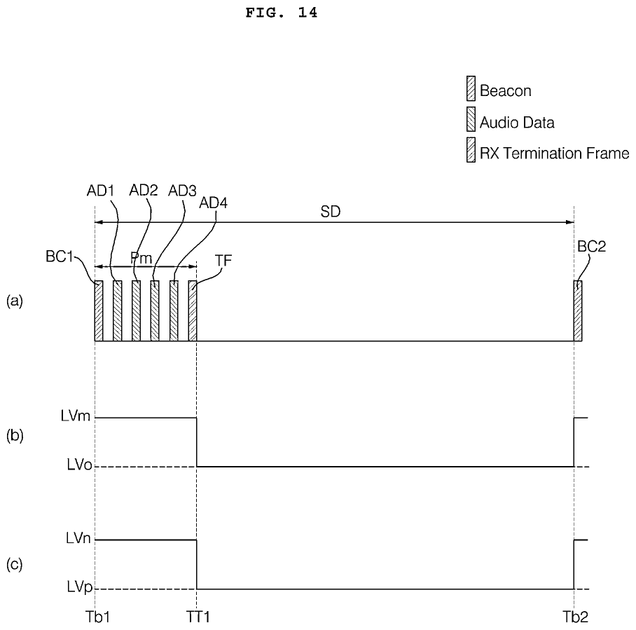

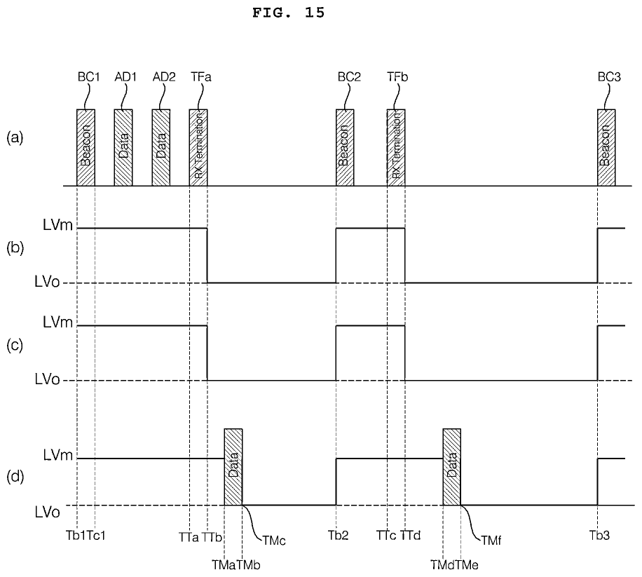

FIG. 14 illustrates another example of operation of a wireless audio receiving device.

Referring to FIG. 14, the transceiver 135 in the wireless audio receiving device 100 may be connected one-to-one with the wireless audio transmitting device 50.

As described above, the transceiver 135 in the wireless audio receiving device 100 may receive the first beacon signal BC1 and the second beacon signal BC2 at time points Tb1 and Tb2, respectively, based on the unicast method of ultra-wideband communication.

The interval between the first beacon signal BC1 and the second beacon signal BC2 may be referred to as the beacon interval of FIG. 3C or a superframe duration SD.

The transceiver 135 in the wireless audio receiving device 100 operates based on the power of the first level LVm, after receiving the first beacon signal BC1.

Next, the transceiver 135 in the wireless audio receiving device 100 may sequentially receive wireless audio data AD1 to AD4 while operating based on the power of the first level LVm.

For example, when connected one-to-one with the wireless audio transmitting device 50, the transceiver 135 in the wireless audio receiving device 100 may sequentially receive wireless audio data AD1 to AD4 during the contention free period CFP.

Correspondingly, the sound output device 160 in the wireless audio receiving device 100 may output sound corresponding to the received wireless audio data AD1 to AD4.

Next, the transceiver 135 in the wireless audio receiving device 100 may receive the end frame information TF, after receiving the wireless audio data AD1 to AD4.

Meanwhile, after receiving the end frame information TF, the transceiver 135 in the wireless audio receiving device 100 may be operated based on the power of the second level LVo lower than the first level LVm or turned off, from the time point TT1 until the reception of the second beacon signal BC2. Accordingly, the power consumption during ultra-wideband communication may be reduced.

Meanwhile, comparing FIG. 14 with FIG. 11A, since the transceiver 135 may be operated based on the power of the second level LVo or turned off, after receiving the end frame information TF, the power consumption may be reduced.

For example, if the period from TT1 until reception of the second beacon signal BC2 is approximately 70% of the beacon interval BI or superframe duration SD, the transceiver 135 in the wireless audio receiving device 100 may be operated with approximately 30% of power consumption. That is, compared to FIG. 11A, power consumption may be reduced by approximately 70%.

Meanwhile, when the transceiver 135 receives the first beacon signal BC1, the power supply 190 in the wireless audio receiving device 100 supplies the power of the third level LVn, as shown in FIG. 14C, and when the transceiver 135 receives the end frame information TF from the wireless audio transmitting device 50 after receiving the first beacon signal (BC1), may supply the power the fourth level LVp lower than the third level LVn. Accordingly, power consumption during ultra-wideband communication may be reduced.

Meanwhile, since the transceiver 135 in the wireless audio receiving device 100 is connected one-to-one with the wireless audio transmitting device 50, it may receive the frame information TF through the network address of the wireless audio receiving device 100.

Meanwhile, in response to receiving the end frame information TF, the transceiver 135 in the wireless audio receiving device 100 may be operated based on the power the second level LVo or turned off, in at least partial section of the active period in the beacon interval BI or superframe duration SD.

In particular, in response to receiving the end frame information TF during one-to-one connection with the wireless audio transmitting device 50, the transceiver 135 in the wireless audio receiving device 100 may be operated based on the power the second level LVo or turned off, in at least partial section of the contention access period CAP in the beacon interval BI or superframe duration SD. Accordingly, power consumption during ultra-wideband communication may be reduced.

FIG. 15 illustrates another example of operation of a wireless audio receiving device.

Referring to FIG. 15, the transceiver 135b of the wireless audio transmitting device 50 may be connected one-to-many with a plurality of wireless audio receiving devices 100a to 100c.

FIG. 15A(a) shows a wireless signal output from the transceiver 135b of the wireless audio transmitting device 50, and FIGS. 15A(b) to (d) show the power level of the transceiver 135 in the wireless audio receiving devices 100a to 100c, respectively.

The transceiver 135b of the wireless audio transmitting device 50 may transmit the first beacon signal BC1, the second beacon signal BC2, and the third beacon signal BC3, at time points Tb1, Tb2, and Tb3, respectively, based on a broadcast method of ultra-wideband communication.

Correspondingly, the transceiver 135 in each wireless audio receiving device 100a to 100c may receive the first beacon signal BC1, the second beacon signal BC2, and the third beacon signal BC3, at time points Tb1, Tb2, and Tb3, respectively.

The transceiver 135 in each wireless audio receiving device 100a to 100c may operate based on the power of the first level LVm, after receiving the first beacon signal BC1.

Meanwhile, the transceiver 135b of the wireless audio transmitting device 50 may transmit the audio data AD1, AD2 according to the broadcast method after transmitting the first beacon signal BC1, i.e., during the competitive access period CAP.

Correspondingly, the transceiver 135 in each wireless audio receiving device 100a to 100c receives the audio data AD1, AD2 during the contention access period CAP, and the sound output devices 160 in each wireless audio receiving device 100a to 100c may output corresponding sound.

Meanwhile, the transceiver 135b of the wireless audio transmitting device 50 may transmit the end frame information TFa according to the broadcast method after transmitting the audio data AD1, AD2.

In the drawing, it is illustrated that the end frame information TFa is transmitted, from the time point TTa to the time point TTb.

Meanwhile, since the transceiver 135 in the first to second wireless audio receiving devices 100a to 100b among the wireless audio receiving devices 100a to 100c has no transmission data to be transmitted, it may be operated based on the power of the second level LVo lower than the first level LVm or may be turned off, from the time point TTb at which the end frame information TFa is received to the time point Tb2 until receiving the second beacon signal BC2. Accordingly, the power consumption during ultra-wideband communication may be reduced. Furthermore, wireless audio data may be received stably.

Meanwhile, since the transceiver 135 in the third wireless audio receiving device 100c among the wireless audio receiving devices 100a to 100c has transmission data TMC to be transmitted, it may transmit the transmission data TMc, at between the time point TMa and the time point TMC.

Correspondingly, the transceiver 135b of the wireless audio transmitting device 50 may receive the transmission data TMC.

Meanwhile, the transceiver 135 in the third wireless audio receiving device 100c among the wireless audio receiving devices 100a to 100c may be operated based on the power of the second level LVo lower than the first level LVm or turned off, from the time point TMc after transmission of the transmission data TMc to the time point Tb2 until receiving the second beacon signal BC2. Accordingly, the power consumption during ultra-wideband communication may be reduced. Furthermore, wireless audio data may be received stably.

Meanwhile, the transceiver 135 in the wireless audio receiving devices 100a to 100c may operate again based on the power of the first level LVm, after receiving the second beacon signal BC2.

After that, the transceiver 135b of the wireless audio transmitting device 50 may transmit the end frame information TFb, according to the broadcast method without transmitting audio data.

In the drawing, it is illustrated that the end frame information TFb is transmitted from the time point TTc to the time point TTd.

Meanwhile, since the transceiver 135 in the first to second wireless audio receiving devices 100a to 100b among the wireless audio receiving devices 100a to 100c has no transmission data to be transmitted, it may be operated based on the power of the second level LVo lower than the first level LVm or may be turned off, from the time point TTb at which the end frame information TFb is received to the time point Tb3 until receiving the third beacon signal BC3. Accordingly, the power consumption during ultra-wideband communication may be reduced. Furthermore, wireless audio data may be received stably.

Meanwhile, since the transceiver 135 in the third wireless audio receiving device 100c among the wireless audio receiving devices 100a to 100c has transmission data (TMc) to be transmitted, it may transmit transmission data TMf, at between the time point TMd and the time point TMe.

Correspondingly, the transceiver 135b of the wireless audio transmitting device 50 may receive transmission data TMf.

Meanwhile, the transceiver 135 in the third wireless audio receiving device 100c among the wireless audio receiving devices 100a to 100c may be operated based on the power of the second level LVo lower than the first level LVm or turned off, from the time point TMe after transmission of the transmission data TMf to the time point Tb3 until receiving the third beacon signal BC3. Accordingly, the power consumption during ultra-wideband communication may be reduced. Furthermore, wireless audio data may be received stably.

Meanwhile, the transceiver 135 in the wireless audio receiving devices 100a to 100c may operate again based on the power of the first level LVm, after receiving the third beacon signal BC3.

Meanwhile, the wireless audio transmitting device 50 in FIGS. 12A to 15 may be a cradle device 200 or a mobile terminal 600.

A wireless audio transmitting device and a wireless audio system including the same according to an embodiment of the present disclosure include a communication device which receives an audio signal from a wireless audio transmitting device through ultra-wideband communication; and a power supply configured to supply power to the communication device, wherein the communication is configured to operate based on a power of a first level in response to receiving a first beacon signal, and operate based on a power of a second level lower than the first level or turn off, in response to receiving end frame information from the wireless audio transmitting device, after receiving the first beacon signal. Accordingly, power consumption during ultra-wideband communication can be reduced. Furthermore, wireless audio data can be received stably.

Meanwhile, in response to no transmission data to be transmitted to the wireless audio transmitting device, the communication is configured to operate based on the power of the second level or turn off, from a time of receiving the end frame information until a time of receiving a second beacon signal following the first beacon signal. Accordingly, power consumption during ultra-wideband communication can be reduced.

Meanwhile, in response to transmission data to be transmitted to the wireless audio transmitting device, the communication device is configured to transmit the transmission data after receiving the end frame information, and operate based on the power of the second level or turn off, after transmitting the transmission data until receiving a second beacon signal following the first beacon signal. Accordingly, power consumption during ultra-wideband communication can be reduced.

Meanwhile, when receiving data after receiving the first beacon signal, receiving the end frame information, and no transmission data to be transmitted to the wireless audio transmitting device, the communication device is configured to operate based on the power of the second level or turn off, after receiving the end frame information until receiving a second beacon signal following the first beacon signal. Accordingly, power consumption during ultra-wideband communication can be reduced.

Meanwhile, the communication device when receiving data after receiving the first beacon signal, and receiving the end frame information, and there is transmission data to be transmitted to the wireless audio transmitting device, the communication device is configured to transmit the transmission data after receiving the end frame information, and operate based on the power of the second level or turn off, after transmitting the transmission data until receiving a second beacon signal following the first beacon signal. Accordingly, power consumption during ultra-wideband communication can be reduced.

Meanwhile, the communication device is configured to receive the end frame information through a network address or broadcast address of the wireless audio receiving device. Accordingly, power consumption during ultra-wideband communication can be reduced.

Meanwhile, in response to receiving the end frame information, the communication is configured to operate based on the power of the second level or turn off, in at least partial section of an active period in a beacon interval. Accordingly, power consumption during ultra-wideband communication can be reduced.

Meanwhile, in response to no data to be transmitted to the wireless audio transmitting device, the communication is configured to operate based on the power of the second level or turn off, after receiving the end frame information until receiving a second beacon signal following the first beacon signal. Accordingly, power consumption during ultra-wideband communication can be reduced.

Meanwhile, in response to transmission data to be transmitted to the wireless audio transmitting device, the communication device is configured to transmit the transmission data after receiving the end frame information, and operate based on the power of the second level or turn off, after transmitting the transmission data until receiving a second beacon signal following the first beacon signal. Accordingly, power consumption during ultra-wideband communication can be reduced.

Meanwhile, in response to receiving the end frame information, the communication is configured to operate based on the power of the second level or turn off, in at least partial section of a contention access period in a beacon interval. Accordingly, power consumption during ultra-wideband communication can be reduced.

Meanwhile, in response to no data to be transmitted to the wireless audio transmitting device, the communication is configured to operate based on the power of the second level or turn off, after receiving the end frame information until receiving a second beacon signal following the first beacon signal. Accordingly, power consumption during ultra-wideband communication can be reduced.

Meanwhile, in response to transmission data to be transmitted to the wireless audio transmitting device, the communication device is configured to transmit the transmission data after receiving the end frame information, and operate based on the power of the second level or turn off, after transmitting the transmission data until receiving a second beacon signal following the first beacon signal. Accordingly, power consumption during ultra-wideband communication can be reduced.

Meanwhile, in response to receiving the end frame information during one-to-one connection or one-to-many connection with the wireless audio transmitting device, the communication is configured to operate based on the power of the second level or turn off, during at least partial section of a contention access period in a beacon interval. Accordingly, power consumption during ultra-wideband communication can be reduced.

Meanwhile, the power supply is configured to supply a power of a third level when the communication device is configured to receive a first beacon signal, and supply a power of a fourth level lower than the third level when the communication device is configured to receive end frame information from the wireless audio transmitting device after receiving the first beacon signal. Accordingly, power consumption during ultra-wideband communication can be reduced.

Meanwhile, a wireless audio receiving device and a wireless audio system including the same further include a sound output device is configured to output sound corresponding to an audio signal received from the communication device. Accordingly, it is possible to output a wireless audio-based sound through ultra-wideband communication.

A wireless audio transmitting device and a wireless audio system including the same according to an embodiment of the present disclosure include: a communication device is configured to transmit an audio signal through an ultra-wideband communication; and a power supply configured to supply power to the communication device, wherein the communication device is configured to transmit end frame information from a wireless audio receiving device, after transmitting a first beacon signal. Accordingly, it is possible to reduce power consumption of the wireless audio receiving device during ultra-wideband communication.

Meanwhile, the communication device is configured to transmit the end frame information through a network address of the wireless audio receiving device during one-to-one connection with the wireless audio receiving device. Accordingly, it is possible to reduce power consumption of the wireless audio receiving device during ultra-wideband communication.

Meanwhile, the communication device is configured to transmit the end frame information through a broadcast address, during one-to-many connection with a plurality of wireless audio receiving devices. Accordingly, it is possible to reduce power consumption of the wireless audio receiving device during ultra-wideband communication.

Meanwhile, the communication device is configured to receive data from a wireless audio receiving device after transmitting end frame information. Accordingly, it is possible to stably receive data from the wireless audio receiving device during ultra-wideband communication.

Although the present disclosure has been described with reference to specific embodiments shown in the drawings, it is apparent to those skilled in the art that the present description is not limited to those exemplary embodiments and is embodied in many forms without departing from the scope of the present disclosure, which is described in the following claims. These modifications should not be individually understood from the technical spirit or scope of the present disclosure.

What is claimed is:

1. A wireless audio receiving device comprising:
a communication device which receives an audio signal a wireless from audio transmitting device through ultra-wideband communication; and
a power supply configured to supply power to the communication device,
wherein the communication is configured to:
operate based on a power of a first level in response to receiving a first beacon signal, and
operate based on a power of a second level lower than the first level or turn off, in response to receiving end frame information from the wireless audio transmitting device, after receiving the first beacon signal.

2. The wireless audio receiving device of claim 1, wherein in response to no transmission data to be transmitted to the wireless audio transmitting device, the communication is configured to operate based on the power of the second level or turn off, from a time of receiving the end frame information until a time of receiving a second beacon signal following the first beacon signal.

3. The wireless audio receiving device of claim 1, wherein in response to transmission data to be transmitted to the wireless audio transmitting device, the communication device is configured to transmit the transmission data after receiving the end frame information, and operate based on the power of the second level or turn off, after transmitting the transmission data until receiving a second beacon signal following the first beacon signal.

4. The wireless audio receiving device of claim 1, wherein when receiving data after receiving the first beacon signal, receiving the end frame information, and no transmission data to be transmitted to the wireless audio transmitting device, the communication device is configured to operate based on the power of the second level or turn off, after receiving the end frame information until receiving a second beacon signal following the first beacon signal.

5. The wireless audio receiving device of claim 1, wherein when receiving data after receiving the first beacon signal, and receiving the end frame information, and there is transmission data to be transmitted to the wireless audio transmitting device, the communication device is configured to transmit the transmission data after receiving the end frame information, and operate based on the power of the second level or turn off, after transmitting the transmission data until receiving a second beacon signal following the first beacon signal.

6. The wireless audio receiving device of claim 1, wherein the communication device is configured to receive the end frame information through a network address or broadcast address of the wireless audio receiving device.

7. The wireless audio receiving device of claim 1, wherein in response to receiving the end frame information, the communication is configured to operate based on the power of the second level or turn off, in at least partial section of an active period in a beacon interval.

8. The wireless audio receiving device of claim 7, wherein in response to no data to be transmitted to the wireless audio transmitting device, the communication is configured to operate based on the power of the second level or turn off, after receiving the end frame information until receiving a second beacon signal following the first beacon signal.

9. The wireless audio receiving device of claim 7, wherein in response to transmission data to be transmitted to the wireless audio transmitting device, the communication device is configured to transmit the transmission data after receiving the end frame information, and operate based on the power of the second level or turn off, after transmitting the transmission data until receiving a second beacon signal following the first beacon signal.

10. The wireless audio receiving device of claim 1, wherein in response to receiving the end frame information, the communication is configured to operate based on the power of the second level or turn off, in at least partial section of a contention access period in a beacon interval.

11. The wireless audio receiving device of claim 10, wherein in response to no data to be transmitted to the wireless audio transmitting device, the communication is configured to operate based on the power of the second level or turn off, after receiving the end frame information until receiving a second beacon signal following the first beacon signal.

12. The wireless audio receiving device of claim 10, wherein in response to transmission data to be transmitted to the wireless audio transmitting device, the communication device is configured to transmit the transmission data after receiving the end frame information, and operate based on the power of the second level or turn off, after transmitting the transmission data until receiving a second beacon signal following the first beacon signal.

13. The wireless audio receiving device of claim 1, wherein in response to receiving the end frame information during one-to-one connection or one-to-many connection with the wireless audio transmitting device, the communication is configured to operate based on the power of the second level or turn off, during at least partial section of a contention access period in a beacon interval.

14. The wireless audio receiving device of claim 1, wherein the power supply is configured to:
supply a power of a third level when the communication device is configured to receive a first beacon signal, and
supply a power of a fourth level lower than the third level when the communication device is configured to receive end frame information from the wireless audio transmitting device after receiving the first beacon signal.

15. The wireless audio receiving device of claim 1, further comprising a sound output device is configured to output sound corresponding to an audio signal received from the communication device.

16. A wireless audio transmitting device comprising:
a communication device is configured to transmit an audio signal through an ultra-wideband communication; and
a power supply configured to supply power to the communication device,
wherein the communication device is configured to transmit end frame information from a wireless audio receiving device, after transmitting a first beacon signal.

17. The wireless audio transmitting device of claim 16, wherein the communication device is configured to transmit the end frame information through a network address of the wireless audio receiving device during one-to-one connection with the wireless audio receiving device.

18. The wireless audio transmitting device of claim 16, wherein the communication device is configured to transmit the end frame information through a broadcast address, during one-to-many connection with a plurality of wireless audio receiving devices.

19. A wireless audio system comprising:
a wireless audio receiving device; and
a wireless audio transmitting device,
wherein the wireless audio receiving device comprises:
a communication device which receives an audio signal from a wireless audio transmitting device through ultra-wideband communication; and
a power supply configured to supply power to the communication device,
wherein the communication is configured to:
operate based on a power of a first level in response to receiving a first beacon signal, and
operate based on a power of a second level lower than the first level or turn off, in response to receiving end frame information from the wireless audio transmitting device, after receiving the first beacon signal.

20. The wireless audio system of claim 19, wherein the wireless audio transmitting device comprises:
a second communication device is configured to transmit an audio signal through an ultra-wideband communication; and
a second power supply configured to supply power to the second communication device,
wherein the second communication device is configured to transmit end frame information from a wireless audio receiving device, after transmitting a first beacon signal.
